(19) United States
(12) Patent Application Publication
(10) Pub. No.: US 2007/0041613 A1
(43) Pub. Date: Feb. 22, 2007

(54) Database of target objects suitable for use in screening receptacles or people and method and apparatus for generating same

(76) Inventors: Luc Perron, Charlesbourg (CA); Michel R. Bouchard, Sainte-Foy (CA); Jacques Regnier, Quebec (CA); Mathieu Lalonde, Beauport (CA); Alain Bergeron, Sainte-Foy (CA); Eric Bergeron, Quebec (CA); Marc-Andre Boucher, Lac-Beauport (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/431,719

(22) Filed: May 11, 2006

Related U.S. Application Data
(63) Continuation-in-part of application No. PCT/CA05/00716, filed on May 11, 2005.
(63) Continuation-in-part of application No. 11/268,749, filed on Nov. 8, 2005.
(63) Continuation-in-part of application No. 11/407,217, filed on Apr. 20, 2006.

(51) Int. Cl. G06K 9/00

(52) U.S. Cl. 382/103

(57) ABSTRACT

A database of target objects suitable for use in detecting the presence of one or more target objects in a receptacle is provided. The database of target objects comprises a plurality of entries, each entry being associated to a respective target object whose presence in a receptacle it is desirable to detect during security screening. An entry for a given target object comprises a group of sub-entries, each sub-entry being associated to the given target object in a respective orientation. At least part of each sub-entry is suitable for being processed by a processing unit implementing an optical correlation operation to attempt to detect a representation of the given target object in an image of the receptacle. A method, an apparatus and a system for generating entries for the database of target objects are also provided.

### CROSS-REFERENCE TO RELATED APPLICATIONS

This application is a continuation-in-part claiming the benefit under 35 USC §120 of international PCT patent application serial number PCT/CA2005/000716 filed on May 11, 2005 by Eric Bergeron et al. and designating the United States.

This application is also a continuation-in-part claiming the benefit under 35 USC §120 of:
U.S. patent application Ser. No. 11/268,749 entitled “METHOD AND SYSTEM FOR SCREENING CARGO CONTAINERS”, filed on Nov. 8, 2005 by Eric Bergeron et al. and presently pending; and
U.S. patent application Ser. No. 11/407,217 entitled “USER INTERFACE FOR USE IN SCREENING LUGGAGE, CONTAINERS, PARCELS OR PEOPLE AND APPARATUS FOR IMPLEMENTING SAME”, filed on Apr. 20, 2006 by Eric Bergeron et al. and presently pending.

The contents of the above referenced applications are incorporated herein by reference.

### FIELD OF THE INVENTION

The present invention relates generally to security systems and, more particularly, to a database of target objects suitable for use in screening luggage, cargo containers, mail parcels or other receptacles to identify certain target objects potentially contained therein or in screening persons to identify certain target objects potentially located thereon. The present invention also relates to a method and apparatus for generating such a database of target objects.

### BACKGROUND

Security in airports, train stations, ports, mail sorting facilities, office buildings and other public or private venues is becoming increasingly important in particular in light of recent violent events.

Typically, for example, security-screening systems at airports make use of devices generating penetrating radiation, such as x-ray devices, to scan individual pieces of luggage to generate an image conveying the contents of the luggage. The image is displayed on a screen and is examined by a human operator whose task it is to detect and identify, on the basis of the image, potentially threatening objects located in the luggage.

A deficiency with current systems is that they are reliant on the human operator to detect and identify potentially threatening objects. However, the performance of the human operator greatly varies according to such factors as poor training and fatigue. As such, the detection and identification of threatening objects is highly susceptible to human error. Another deficiency with current systems is that the labour costs associated with such systems are significant since human operators must view the images. It will be appreciated that failure to detect and identify a threatening object, such as a weapon, for example, may have serious consequences, such as property damage, injuries and fatalities.

Consequently, there is a need in the industry for providing a method and system for use in screening luggage items, mail parcels, cargo containers, other types of receptacles, or persons to identify certain objects that alleviate at least in part the deficiencies of the prior art.

### SUMMARY OF THE INVENTION

In accordance with a broad aspect, the invention provides a computer readable storage medium storing a database of target objects suitable for use in detecting the presence of one or more target objects in a receptacle. The database of target objects comprises a plurality of entries, each entry being associated to a respective target object whose presence in a receptacle it is desirable to detect during security screening. An entry for a given target object comprises a group of sub-entries, each sub-entry being associated to the given target object in a respective orientation. At least part of each sub-entry is suitable for being processed by a processing unit implementing an optical correlation operation to attempt to detect a representation of the given target object in an image of the receptacle.

In accordance with a specific implementation, each sub-entry in the group of sub-entries includes a component indicative of a filter, the filter being derived on the basis of an image of the given target object in a certain orientation. The filter may take on a number of possible forms. In very specific practical examples of implementation, the filters may be indicative of:
a Fourier transform of the image of the given target object in the certain orientation;
an image of a Fourier transform of the image of the given target object in the certain orientation;
a data element derived on the basis of a function of a Fourier transform of the image of the given target object in the certain orientation;
a data element derived on the basis of a function of a Fourier transform of a composite image, the composite image including at least the image of the given target object in the certain orientation.

The number of sub-entries for each entry in the database of target objects may vary from one target object to the other and may vary from one implementation to the next without detracting from the spirit of the invention. Typically, the number of sub-entries selected to a given target object will be based on a desired balance between processing speed and recognition accuracy.

In accordance with a specific implementation, the group of sub-entries in the entry for the given target object is first information, the entry for the given target object further includes second information suitable for being processed by a computing apparatus to derive a pictorial representation of the given target object.

In accordance with a specific implementation, the group of sub-entries in the entry for the given target object comprises third information associated with the given target object. The third information may convey one or more additional information elements associated to the target object such as, for example:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

In accordance with a specific implementation, the computer readable storage medium further comprises a program element adapted to interact with the database of target objects. The program element is responsive to a query signal requesting information associated to a certain target object for locating in the database of target objects an entry corresponding to the certain target object. The program element is also operative for extracting information from the entry corresponding to the certain target object on the basis of the query signal and for releasing a signal conveying the information extracted for transmission to an entity distinct from the database of target objects.

In accordance with another broad aspect, the invention provides a method for generating an entry in a database of target objects suitable for use in detecting the presence of one or more target objects in a receptacle. The method comprises obtaining a plurality of images of a given target object whose presence in a receptacle it is desirable to detect during security screening, each image of the given target object in the plurality of images corresponding to the given target object in a respective orientation. The method also comprises processing each image in the plurality of images to generate respective filter data elements, the filter data elements being suitable for being processed by a processing unit implementing an optical correlation operation to attempt to detect a representation of the given target object in an image of a receptacle. The method also comprises storing the filter data elements in the database of target objects in association with an entry corresponding to the given target object.

In accordance with a specific implementation, obtaining a plurality of images of the given target object comprises sequentially positioning and obtaining an image of the given target object in orientations selected from a set of orientations. The images of the given target object may be derived using any suitable imaging method including penetrating radiation and emitted radiation. In a specific example, the plurality of images of the given target object are x-ray images.

In accordance with a specific implementation, as part of the generation of filter data elements, the method comprises computing Fourier transforms associated to the respective images in the plurality of images of the given target object. Optionally, data conveying the plurality of images of the given target object in association with the entry in the database of target objects corresponding to the given target object is also stored.

In accordance with a specific implementation, the method comprises storing supplemental data in association with the entry corresponding to the given target object, at least part of the supplemental data being suitable for being processed to derive an image conveying pictorial information associated to the given target object. Other supplementation information may also be stored in association with the entry corresponding to the given target object, such as for example:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

In accordance with a specific practical implementation, the method may comprise providing the contents of the database of target objects to a facility including a security screening station for use in detecting in a receptacle the presence of one or more target objects from the database of target objects. The screening station may be located, for example, in an airport, mail sorting station, border crossing, train station, building or any other environment where screening receptacles for certain objects is desirable. Alternatively, the method may comprise providing the contents of the database of target objects to a customs station for use in detecting in a receptacle the presence of one or more target objects from the database of target objects.

In accordance with another broad aspect, the invention provides a computer readable storage medium storing a program element suitable for execution by a computing apparatus for generating an entry in a database of target objects suitable for use in detecting the presence of one or more target objects in a receptacle in accordance with the above described method.

In accordance with another broad aspect, the invention provides an apparatus for generating an entry in a database of target objects in accordance with the above described method, the database of target objects being suitable for use in screening receptacles to detect the presence of one or more target objects.

In accordance with yet another broad aspect, the invention provides a system for generating an entry in a database of target objects suitable for use in screening receptacles to detect the presence of one or more target objects. The system comprises an image generation device suitable for generating image signals associated with a given target object whose presence in a receptacle it is desirable to detect during security screening. Each image signal associated with the given target object corresponds to the given target object in a respective orientation. The system also comprises a database of target objects suitable for storing a plurality of entries, each entry being associated to a respective target object. The system also comprises an apparatus in communication with the image generation device and with the database of target objects. The apparatus comprises an input for receiving the image signals associated with the given target object from the image generation device and a processing unit in communication with the input. The processing unit is operative for processing the image signals associated with the given target object to generate respective filter data elements. The filter data elements are suitable for being processed by a device implementing an optical correlation operation to attempt to detect a representation of the given target object in an image of a receptacle. The processing unit is operative for storing the filter data elements in the database of target objects in association with an entry corresponding to the given target object.

In accordance with a specific implementation, the system comprises a positioning device for positioning the given target object in two or more distinct orientations such as to allow the image generation device to generate image signals associated with the given target object in the two or more distinct orientations.

In accordance with yet another broad aspect, the invention provides an apparatus for generating an entry in a database of target objects suitable for use in screening receptacles to detect the presence of one or more target objects. The apparatus comprises means for receiving signals conveying a plurality of images of a given target object whose presence in a receptacle it is desirable to detect during security screening. Each image of the given target object in the plurality of images corresponds to the given target object in a respective orientation. The apparatus also comprises means for processing each image in the plurality of images to generate respective filter data elements. The filter data elements are suitable for being processed by a processing unit implementing an optical correlation operation to attempt to detect a representation of the given target object in an image of a receptacle. The apparatus also comprises means for storing the filter data elements in the database of target objects in association with an entry corresponding to the given target object.

In accordance with yet another broad aspect, the invention provides a system for detecting the presence of one or more target objects in a receptacle. The system comprises an input for receiving data conveying graphic information regarding the contents of the receptacle. The system also comprises a database of target objects comprising a plurality of entries, each entry being associated to a respective target object whose presence in a receptacle it is desirable to detect. At least one entry is associated to a given target object and includes a group of sub-entries, each sub-entry being associated to the given target object in a respective orientation. The system further comprises an optical correlator in communication with the input and with the database of target objects. The optical correlator is operative for processing the graphic information regarding the contents of the receptacle in combination with at least part of a sub-entry associated to the given target object to attempt to detect the given target objects in the receptacle.

In accordance with a specific implementation, each sub-entry in the group of sub-entries includes a component indicative of a filter, the filter being derived on the basis of an image of the given target object in a certain orientation.

In accordance with a specific practical implementation, the system is part of a security screening station or part of a customs station for example.

In accordance with yet another broad aspect, the invention provides a computer readable storage medium storing a database of target objects suitable for use in detecting the presence of one or more target objects in a receptacle. The database of target objects comprises a plurality of entries, each entry being associated to a respective target object whose presence in a receptacle it is desirable to detect during screening. An entry for a given target object comprises a group of sub-entries, each sub-entry being associated to the given target object in a respective orientation. At least part of each sub-entry is suitable for being processed by a processing unit implementing an optical correlation operation to attempt to detect a representation of the given target object in the receptacle. The entry for the given target object also includes a data element associated with the given target object suitable for being processed by a computing apparatus to derive a monetary value associated with the given target object.

In specific examples of implementation, the data element may be indicative of:
the actual monetary value of the given target object;
the value of the given target object for customs purposes;
some other data, such as the size or weight of the given target object, that may be used to calculate a monetary value.

For the purpose of this specification, the expression “receptacle” is used to broadly describe an entity adapted for receiving objects therein such as, for example, a luggage item, a cargo container or a mail parcel.

For the purpose of this specification, the expression “luggage item” is used to broadly describe luggage, suitcases, handbags, backpacks, briefcases, boxes, parcels or any other similar type of item suitable for containing objects therein.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

A detailed description of certain embodiments of the present invention is provided herein below, by way of example only, with reference to the accompanying drawings, in which:

FIG. 1 is a high-level block diagram of a system for screening a receptacle to detect therein the presence of one or more target objects in accordance with a specific example of implementation of the present invention;

FIG. 2 is a block diagram of an output module suitable for use in connection with the system depicted in FIG. 1 in accordance with a specific example of implementation of the present invention;

FIG. 3 is a diagram depicting a representation of data stored in a database of target objects on a computer readable medium in accordance with a specific example of implementation of the present invention;

FIG. 4 is a block diagram of a computer readable medium storing a program element and a database of target objects in accordance with a specific example of implementation of the present invention;

FIGS. 5a and 5b depict viewing windows of a user interface module displayed by the output module of FIG. 2 in accordance with a specific example of implementation of the present invention;

FIG. 5c depicts a viewing window of a user interface module displayed by the output module of FIG. 2 in accordance with an alternative specific example of implementation of the present invention;

FIG. 6 is a block diagram of an apparatus for processing images suitable for use in connection with the system depicted in FIG. 1 in accordance with a specific example of implementation of the present invention;

FIG. 7 is a flow diagram depicting a process for detecting a presence of at least one target object in the receptacle in accordance with specific examples of implementation of the present invention;

FIG. 8 shows three images associated to a target object suitable for use in connection with the system depicted in FIG. 1, each image depicting the target object in a different orientation, in accordance with a specific example of implementation of the present invention;

FIG. 9 shows a mosaic image including a plurality of sub-images associated with a target object suitable for use in connection with the system depicted in FIG. 1, each sub-image depicting the target object in a different orientation and scale, in accordance with a specific example of implementation of the present invention;

FIG. 10 is a block diagram a receptacle screening system including an optical correlator in accordance with a specific example of implementation of the present invention;

FIG. 11 is a block diagram depicting the functioning of an optical correlator in accordance with a specific example of implementation of the present invention;

FIG. 12 is a block diagram of a system for generating a database of target objects in accordance with a specific example of implementation of the present invention;

FIGS. 13a and 13b depict a positioning device for positioning a given target object in two or more distinct orientations such as to allow an image generation device to generating image signals associated with the given target object in the two or more distinct orientations in accordance with a specific example of implementation of the present invention;

FIG. 14 is a flow diagram depicting a process for generating a database of target objects in accordance with a specific example of implementation of the present invention;

FIG. 15 depicts a Fourier transform, amplitude and phase, of the spatial domain image for number 2;

FIG. 16 shows two images associated to a person suitable for use in a system for screening a person to detect the presence of one or more target objects in accordance with a specific example of implementation of the present invention;

FIG. 17 is a block diagram of an apparatus suitable for implementing certain portions of the system for screening a receptacle shown in FIG. 1 in accordance with a specific example of implementation of the present invention;

FIG. 18 is a block diagram of an apparatus for processing images suitable for use in connection with the system depicted in FIG. 1 in accordance with an alternative specific example of implementation of the present invention; and

FIG. 19 shows a diagram of a client-server system suitable for use in screening a receptacle to detect therein the presence of one or more target objects in accordance with an alternative specific example of implementation of the present invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF EMBODIMENTS

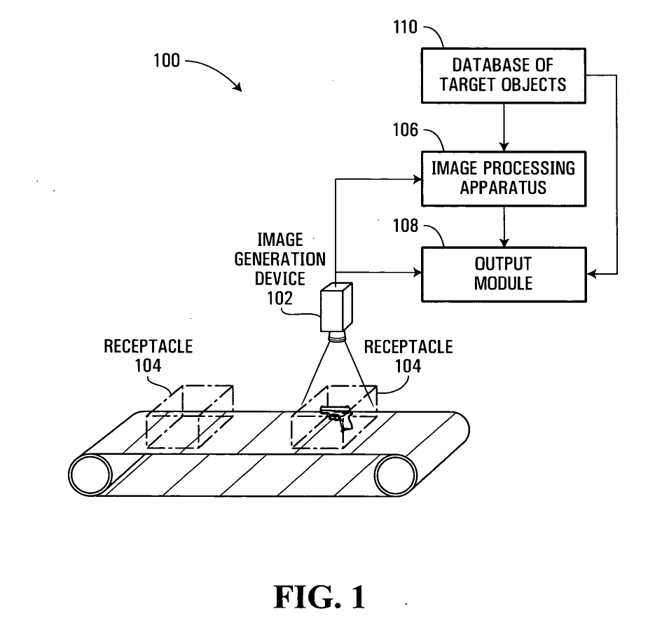

Shown in FIG. 1 is a system 100 for screening a receptacle 104 in accordance with a specific example of implementation of the present invention. The system 100 includes an image generation device 102, an apparatus 106 in communication with the image generation device 102 and an output module 108.

The image generation device 102 generates an image signal associated with the receptacle 104. The image signal conveys information related to the contents of the receptacle 104. The apparatus 106 receives the image signal associated with the receptacle 104 and processes that image signal in combination with a plurality of entries associated with target objects to detect a presence of at least one target object in the receptacle 104. In a specific implementation, data associated with the plurality of entries is stored in a database of target objects 110. The contents of the database of target objects 110 as well as the manner in which this database can be generated will be described later on in the specification. In response to detection of the presence of at least one target object in the receptacle 104, the apparatus 106 generates a detection signal conveying the presence of the target object in the receptacle 104. Examples of the manner in which the detection signal can be derived are described later on in the specification. The output module 108 conveys information derived at least in part on the basis of the detection signal to a user of the system.

Advantageously, the system 100 provides assistance to the human security or screening personnel using the system in detecting certain target objects, including prohibited objects, and decreases the susceptibility of the screening process to human error.

Image Generation Device 102

In a specific example of implementation, the image generation device 102 uses penetrating radiation or emitted radiation to generate the image signal associated with the receptacle 104. Specific examples of such devices include, without being limited to, x-ray, gamma ray, computed tomography (CT scans), thermal imaging and millimeter wave devices. Such devices are known in the art and as such will not be described further here. In a non-limiting example of implementation, the image generation device 102 is a conventional x-ray machine adapted for generating an x-ray image of the receptacle 104.

The image signal generated by the image generation device 102 and associated with the receptacle 104 may be conveyed as a two-dimensional (2-D) image or as a three-dimensional (3-D) image and may be in any suitable format. Possible formats include, without being limited to, JPEG, GIF, TIFF and bitmap amongst others. Preferably, the image signal is in a format that can be displayed on a display screen.

Database of Target Objects 110

Exemplary embodiments of the database of target objects 110 will now be described with reference to the drawings.

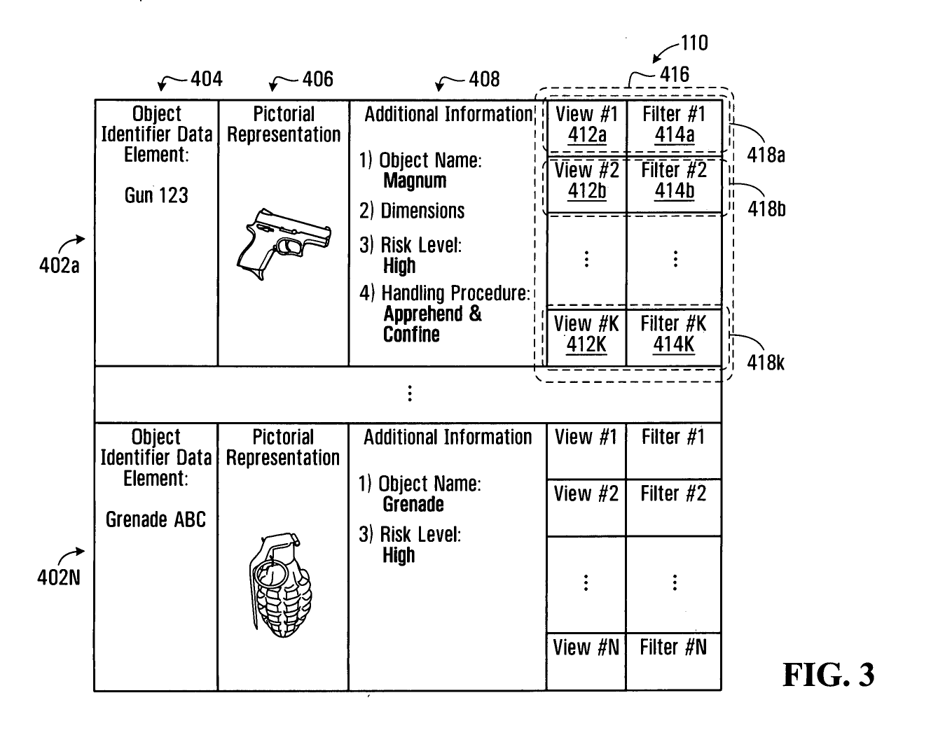

FIG. 3 is a diagram depicting a representation of data stored in the database of target objects 110 on a computer readable medium in accordance with a specific example of implementation of the present invention.

As depicted, the database of target objects 110 comprises a plurality of entries 402a 402N, each entry being associated to a respective target object whose presence in a receptacle it is desirable to detect during security screening.

The types of target objects having entries in the database of target objects 110 will depend upon the application in which the database of target objects 110 is being used and on the target objects the system 100 (shown in FIG. 1) is designed to detect.

For example, if the database of target object 110 is used in the context of luggage screening in an airport, it will be desirable to detect certain types of target objects which may, for example, present a security risk. Alternatively, if the database of target objects 110 is used in the context of cargo container screening at a port, it will be desirable to detect other certain types of target objects. For example, these other types of objects may include contraband items, items omitted from a manifest or simply items which are present in the manifest associated to the cargo container. In the non-limiting example depicted in FIG. 3, the database of target objects 110 includes, amongst others, an entry 402a associated to a gun and an entry 402N associated to a grenade. When the database of target objects 110 is used in a security type of application, at least some of the entries in the database of target objects 110 will be associated to prohibited objects such as weapons or other threat objects.

As depicted, an entry 402a for a given target object includes a group 416 of sub-entries 418a 418b 418K. Each sub-entry 418a 418b 418K is associated to the given target object in a respective orientation. In the specific embodiment depicted in FIG. 3, sub-entry 418a is associated to a first orientation of the target object (Gun123); sub-entry 418b is associated to a second orientation of the target object (Gun123); and sub-entry 418K is associated to a K-th orientation of the target object (Gun123), where K is the number of sub-entries in the group of sub-entries 416. In a specific example of implementation, each orientation of the target object corresponds to an image of the target object taken when the object is in a different position.

The number of sub-entries in a given entry may depend on a number of factors including, but not limited to, the type of application in which the database of target objects 110 is intended to be used, the target object associated to the given entry and the desired speed and accuracy of the overall screening system in which the database of target objects 110 is intended to be used. More specifically, certain objects have shapes that, due to their symmetric properties, do not require a large number of orientations in order to be adequately represented. Take for example images of a spherical object which, irrespective of the orientation of the sphere, will look substantially identical to one another and therefore the group of sub-entries 416 may include a single sub-entry for such an object. However, an object having a more complex shape, such as a gun, would require multiple sub-entries in order to represent the different appearances of the object when in different orientations. The greater the number of sub-entries in the group of sub-entries 416 for a given target object, the more precise the attempt to detect a representation of the given target object in an image of a receptacle can be. However, this also means that a larger number of sub-entries must be processed which increases the time required to complete the processing. Conversely, the smaller the number of sub-entries in the group of sub-entries 416 for a given target object, the faster the speed of the processing can be performed but the less precise the detection of that target object in an image of a receptacle. As such, the number of sub-entries in a given entry is a trade-off between the desired speed and accuracy and may depend on the target object itself as well. In non-limiting examples of implementations, the group of sub-entries 416 includes four or more sub-entries.

At least part of each sub-entry 418a 418b 418K is suitable for being processed by a processing unit implementing an optical correlation operation to attempt to detect a representation of the given target object in an image of the receptacle 104.

More specifically, each sub-entry 418a 418b 418K in the group of sub-entries 416 includes a component indicative of a filter 414a 414b 414K. Each filter is derived at least in part on the basis of an image of the given target object in a certain orientation. In a specific example of implementation, each sub-entry 418a 418b 418K includes data indicative of the Fourier transform (or Fourier transform complex conjugate) of an image of the target object. This data is referred to as a template or filter. In a specific example of implementation, each filter is indicative of a Fourier transform of the image of the given target object in the certain orientation. The Fourier transform may be stored in mathematical format or as an image of the Fourier transform of the image of the given target object in the certain orientation. In another specific example of implementation, each filter is derived at least in part on the basis of a function of Fourier transform of the image of the given target object in the certain orientation. In yet another specific example of implementation, each filter is derived at least in part on the basis of a function of Fourier transform of a composite image, the composite image including at least the image of the given target object in the certain orientation. Specific examples of the manner in which a given filter may be derived will be described later on in the specification.

In a specific example of implementation, each sub-entry 418a 418b 418K in the group of sub-entries 416 includes a second component 412a 412b 412K indicative of an image of the given target object in the certain orientation corresponding to the sub-entry. In a non-limiting example of implementation, the second component 412a 412b 412K is the image on the basis of which the associated filter 414a 414b 414K was derived. It will be readily appreciated that the second component 412a 412b 412K may be omitted from certain implementations of the database of target objects 110 without detracting from the spirit of the invention.

As a variant, in addition to the group of sub-entries 416, the entry 402a may also include a component 406 suitable for being processed by a computing apparatus to derive a pictorial representation of the target object associated to the entry 402a. Any suitable format for storing the component 406 may be used without detracting from the spirit of the invention. Such formats may include, without being limited to, bitmaps, jpeg, gif or any other suitable format in which a pictorial representation of an object may be stored.

As another variant, in addition to the group of sub-entries 416, the entry 402a may also include additional information 408 associated with the given target object. The additional information 408 stored in connection with a given entry will depend upon the type of target object to which the entry is associated as well as the specific application in which the database of target objects 110 is intended to be used. As such, the additional information 408 will vary from one specific implementation to the other. Examples of the additional information 408 include, without being limited to:
a) a risk level associated with the given target object;
b) a handling procedure associated with the given target object;
c) a dimension associated with the given target object;
d) a weight data element associated with the given target object;
e) a description of the given target object;
f) a monetary value associated with the given target object or a data element allowing a monetary value associated with the given target object to be derived;
g) any other type of information associated with the given target object that may be useful in the application in which the database of target objects 110 is intended to be used.

In a non-limiting specific implementation, the risk level information (item a) above) associated to the given target object conveys the relative risk level of a target object compared to other target objects in the database of target objects 110. For example, a gun would be given a relatively high risk level while a metallic nail file would be given a relatively low risk level, and a pocket knife would be given a risk level between that of the nail file and the gun.

In the specific example depicted in FIG. 3, each entry 402a 402N in the database of target objects 110 includes a target object identifier data element 404. The object identifier data element 404 allows each entry in the database to be uniquely identified and accessed for processing.

In a possible variant, an entry for a given target object may include a data element associated with the given target object. The data element can be processed by a computing apparatus to derive a monetary value associated with the given target object. Such a monetary value is particularly useful in applications where the value of the content of a receptacle is of importance such as, for example, mail parcels delivery and customs applications. The data element may be an actual monetary value such as the actual value of the given target object or the value of the given target object for customs purposes. Alternatively, the data element may allow a monetary value to be computed such as a weight or size associated to the given target object.

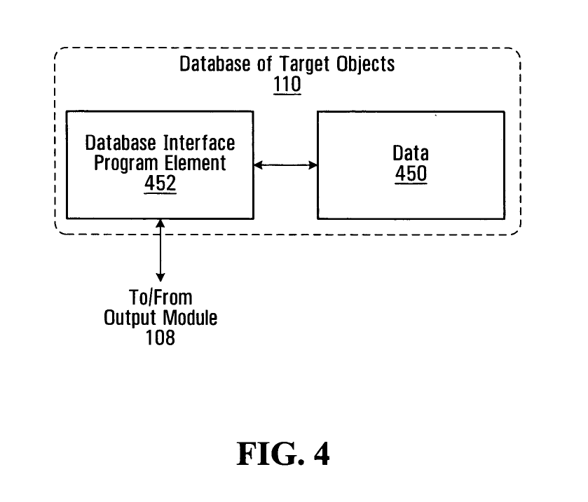

As indicated above, the database of target objects 110 may be stored on a computer readable storage medium that is accessible by a processing unit. Optionally, the database of target objects 110 may be provided with a program element implementing an interface adapted to interact with the database of target objects and an external entity. Such an alternative embodiment is depicted in FIG. 4. In this embodiment, the database of target objects 110 includes a program element 452 implementing a database interface and a data store 450 for storing the data of the database of target objects 110. Amongst others, the program element 452 when executed by a processor is responsive to query signals requesting information associated to a certain target object for locating in the database of target objects an entry corresponding to the certain target object. Once the entry is located, the program element 452 extracts information from the entry corresponding to the certain target object on the basis of the query signal. The program element is then adapted for causing a signal conveying the information extracted to be transmitted to an entity distinct from the database of target objects 110. The external entity may be, for example, the output module 108 (shown in FIG. 1). The query signal may take on a number of suitable formats without detracting from the spirit of the invention. The specific format of the query signal is not critical to the present invention and as such will not be described further here.

Although the database of target objects 110 has been described with reference to FIG. 3 as including certain types of information, it will be appreciated that specific design and content of the database of target objects 110 may vary from one implementation to the next without detracting from the spirit of the invention, depending upon the application and system in which the database of target objects 110 is intended to be used.

Also, although the database of target objects 110 has been shown in FIG. 1 to be a component separate from the apparatus 106, it will be appreciated that in certain embodiments the database of target objects 110 may be part of the apparatus 106 and that such implementations do not detract from the spirit of the invention. In addition, it will also be appreciated that in certain implementations, the database of target objects 110 is shared between multiple apparatuses 106.

Output Module 108

In a specific example of implementation, the output module 108 conveys to a user of the system 100 information derived at least in part on the basis of the detection signal released by the image processing apparatus 106. Examples of the type of information that may be received in the detection signal include information on the position of the target object detected, information about the level of confidence of the detection and data allowing identification of the target object detected.

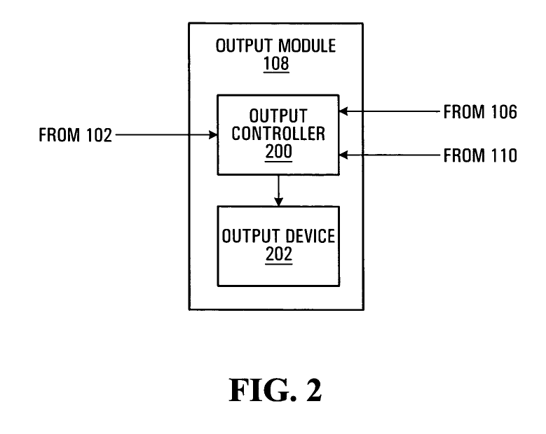

A specific example of implementation of the output module 108 is shown in FIG. 2 of the drawings. As depicted, the output module 108 includes an output device 202 and an output controller unit 200.

The output device 202 may be any device suitable for conveying information to a user of the system 100 regarding the presence of a target object in the receptacle 104. The information may be conveyed in visual format, audio format or as a combination of visual and audio formats. In a first specific example of implementation, the output device 202 is in communication with the output module 200 and includes a display unit adapted for displaying in visual format information related to the presence of a target object in the receptacle 104 on the basis of a signal received from the output module 200. In a second specific example of implementation, the output device 202 includes a printer adapted for displaying in printed format information related to the presence of a target object in the receptacle 104. In a third specific example of implementation, the output device 202 includes an audio output unit adapted for releasing an audio signal conveying information related to the presence of a target object in the receptacle 104. In a fourth specific example of implementation, the output device 202 includes a set of visual elements, such as lights or other suitable visual elements, adapted for conveying in visual format information related to the presence of a target object in the receptacle 104. The person skilled in the art will readily appreciate, in light of the present specification, that other suitable types of output devices may be used here without detracting from the spirit of the invention.

A detection signal conveying a presence of at least one target object in the receptacle 104 is received by the output controller unit 200. In a specific implementation, the detection signal is provided by the image processing apparatus 106. The type of information in the detection signal depends on the specific implementation of the image processing apparatus 106 and may vary from one implementation to the next without detracting from the spirit of the invention. Examples of the type of information that may be received include information on the position of the target object detected, information about the level of confidence of the detection and data allowing identification of the target object detected (e.g., a target object identifier data element associated to an entry in the database of target objects 110).

Information associated to the one or more target objects detected in the receptacle 104 may also be received by the output controller unit 200 from the database of target objects 110. The type of information received depends on the content of the database of target objects 110 and may vary from one implementation to the next. Examples of the type of information that may be received include an image depicting a pictorial representation of the target object and characteristics of the target object. Such characteristics may include, without being limited to, the name of the target object, dimensions of the target object, its associated threat level, the recommended handling procedure when such a target object is detected and any other suitable information.

In a first specific example of implementation, the output controller unit 200 implements a graphical user interface module for conveying information to the user. In such an implementation, the output controller unit 200 is adapted for communicating with the output device 202 that includes a display screen for causing the latter to display the graphical user interface module generated.

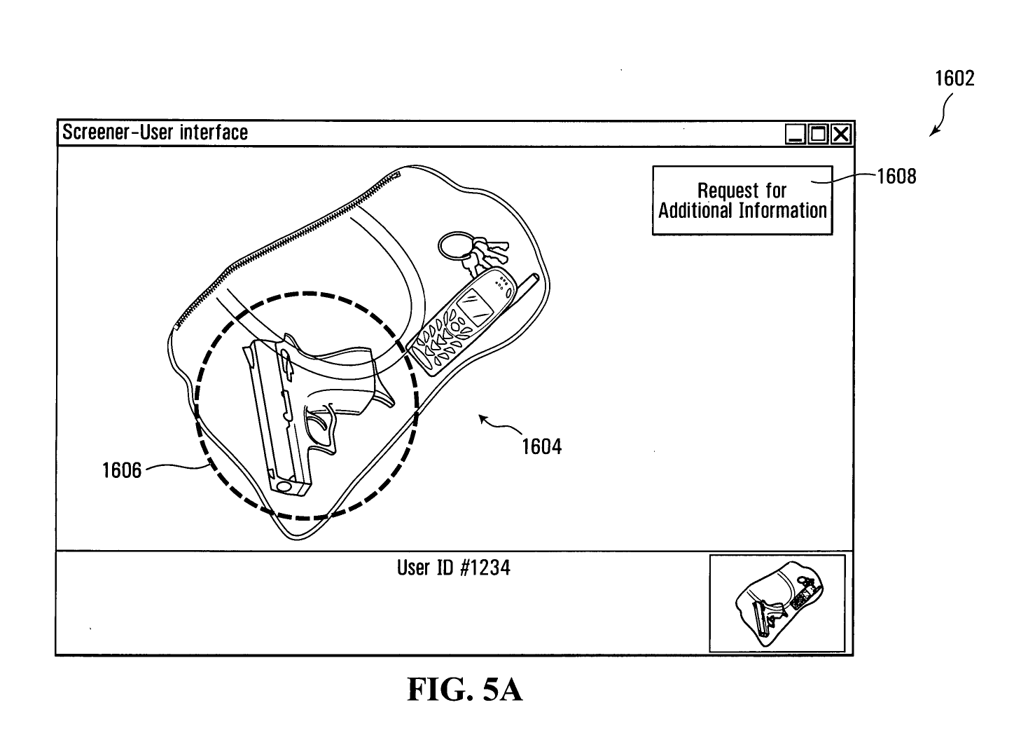

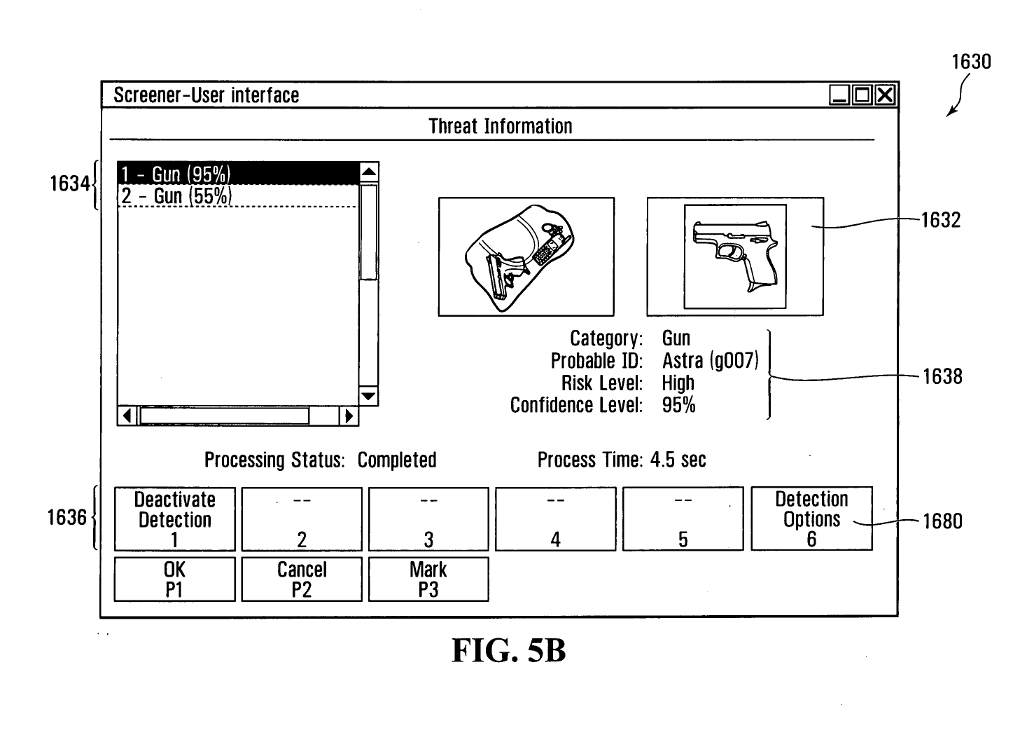

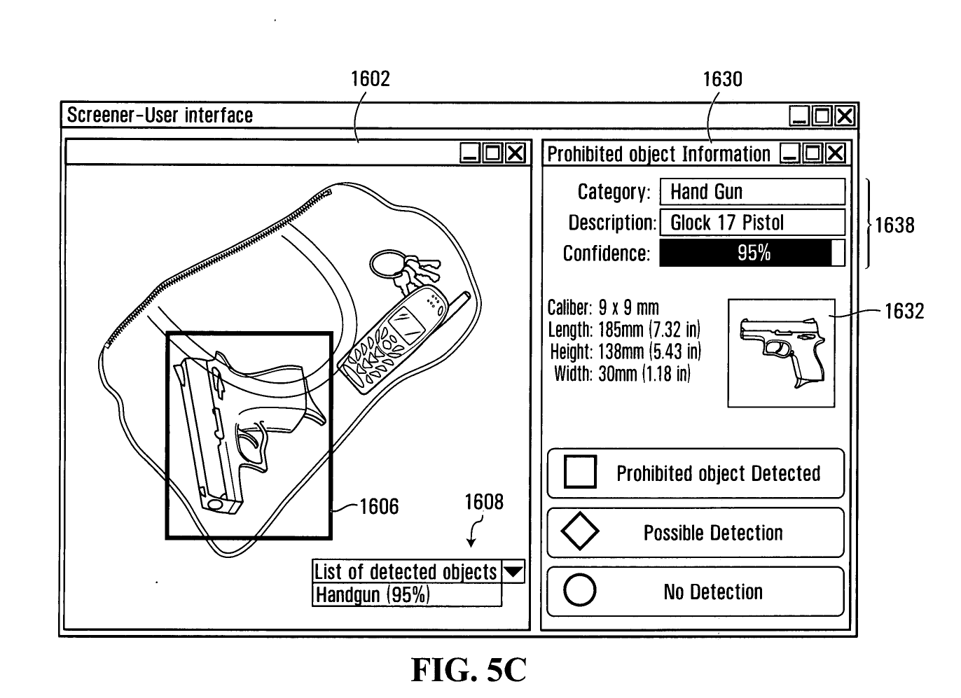

With reference to FIG. 5a, there is shown a display generated by a graphical user interface module in accordance with a non-limiting implementation on the invention. As depicted, the user interface module displays first information 1604 conveying an image associated with a receptacle on the basis of the image signal received from the image generation device 102. The image associated with the receptacle may be in any suitable format and will depend on the format of the image signal received. For example, the image may be of an x-ray, gamma-ray, computed tomography (CT scans), emitted radiation or millimeter wave type, amongst others.

The user interface module also displays second information 1606 conveying a presence of one or more target objects in the receptacle on the basis of the detection signal received from the image processing apparatus 106. The second information 1606 is derived at least in part on the basis of the detection signal received. Preferably, the second information 1606 is displayed simultaneously with the first information 1604. In a specific example, the second information 1606 conveys position information related to one or more target objects whose presence in the receptacle was detected. The second information 1606 may convey the presence of one or more target objects in the receptacle in textual format, in graphical format or as a combination of graphical information and textual information. In textual format, the second information 1606 may appear in a dialog box with a message of the form “A ###target object name ### has been detected.”

The user interface module also allows third information to be displayed, the third information conveying characteristics associated to the one or more detected target objects. Optionally, as in the specific implementation depicted in the FIG. 5a, a control 1608 allows the user to cause the third information to be selectively displayed by using an input device such as, for example, a mouse, keyboard, pointing device, speech recognition unit and touch sensitive screen. Alternatively, the third information may be automatically displayed.

In a specific example of implementation, the first information 1604 and the second information 1606 are displayed in a first viewing window 1602 and the third information is displayed in a second viewing window 1630 of the type depicted in FIG. 5b. FIG. 5c of the drawings depicts an alternative embodiment of a user interface module where the first and second viewing windows 1602 and 1630 are displayed concurrently.

With reference to FIG. 5b, the second viewing window 1630 is for displaying third information conveying one or more characteristics associated to the one or more target objects detected in the receptacle. The type of data conveyed by the third information will vary from one implementation to another.

In the specific example depicted in FIG. 5b, the third information conveys a pictorial representation 1632 and object characteristics 1638 including a description, a risk level and a level of confidence for the detection, each of the above being associated with one of the target objects that was detected. Other types of information that may be conveyed include, without being limited to: a name of the object detected, a handling procedure when such a target object is detected, dimensions of the target object or any other characteristics of the target object that could assist the user in validating the information provided, confirm its presence, or facilitate its handling. The third information may be conveyed in textual formal or graphical format.

In a specific example of implementation, the output controller unit 200 is adapted to transmit a query signal to the database of target objects 110 (shown in FIG. 1), on the basis of information in the detection signal, in order to obtain certain information elements associated to a detected target object, for example an image, a description, a risk level and a handling procedure amongst others. In response to the query signal, the database of target objects 110 transmits the requested information to the output controller unit 200. Alternatively, a signal conveying information associated with one of the target objects that was detected can be automatically provided to the output controller unit 200 by the database of target objects 110 without requiring a query signal to be sent.

In the specific example of implementation depicted in FIG. 5b, the graphical user interface module displays a target object list 1634 including a plurality of entries, each entry being associated to a corresponding target object whose presence in the receptacle was detected. Optionally, each entry in the list of entries 1634 includes information conveying a threat level (not shown in the figures) associated to the corresponding target object in the receptacle. The information conveying a threat level is extracted from the signal received from the database of target objects 110. The threat level information associated to the target object may convey the relative threat level of a target object compared to other target objects in the database of target objects 110. For example, a gun would be given a relatively high threat level while a metallic nail file would be given a relatively low threat level and perhaps a pocket knife would be given a threat level between that of the nail file and the gun.

Thus, in one embodiment, the output controller unit 200 may implement a user interface that releases a signal for causing the output device 202, which includes a display, to convey the user interface to a user of the system. For specific examples of embodiments of user interface modules that may be implemented by the output controller unit 200, the user is invited to refer to co-pending U.S. patent application entitled “USER INTERFACE FOR USE IN SCREENING LUGGAGE, CONTAINERS, PARCELS OR PEOPLE AND APPARATUS FOR IMPLEMENTING SAME”, filed on Apr. 20, 2006 by Eric Bergeron et al. under Ser. No. 11/407,217 and presently pending, the contents of which are incorporated herein by reference.

In another specific example of implementation, the output controller unit 200 is adapted to cause an audio unit to convey information related to the certain target object in the receptacle 104. In one embodiment, the output controller unit 200 generates audio data conveying the presence of the certain target object in the receptacle 104, the location of the certain target object in the receptacle 104 and the characteristics of the target object.

Apparatus 106

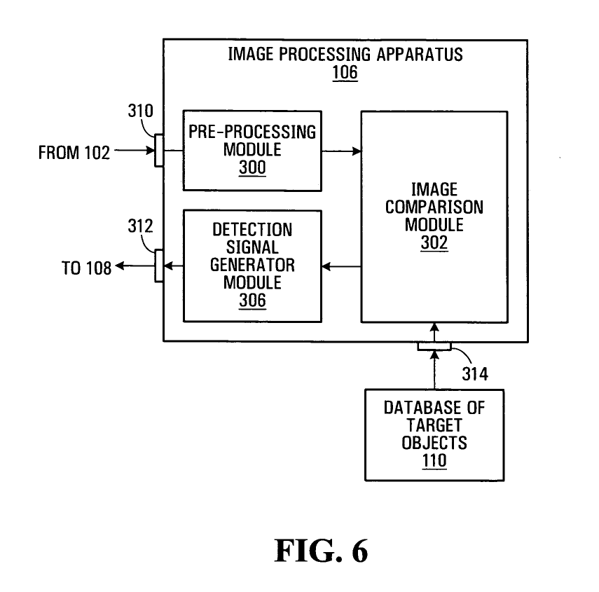

The apparatus 106 will now be described in greater detail with reference to FIG. 6. As depicted, the apparatus 106 includes a first input 310, a second input 314, an output 312 and a processing unit, generally comprising a pre-processing module 300, an image comparison module 302 and a detection signal generator module 306.

The first input 310 is for receiving an image signal associated with the receptacle 104 from the image generation device 102 (shown in FIG. 1).

The second input 314 is for receiving data from the database of target objects 110. It will be appreciated that in embodiments where the database of target objects 110 is part of the apparatus 106, the second input 314 may be omitted.

The output 312 is for releasing a detection signal conveying the presence of a target object in the receptacle 104 for transmittal to output module 108.

The processing unit of the apparatus 106 receives the image signal associated with the receptacle 104 from the first input 310 and processes that image signal in combination with a plurality of entries associated with target objects received at input 314 to detect a presence of a target object in the receptacle 104. In response to detection of the presence of at least one target object in the receptacle 104, the processing unit of the apparatus 106 generates and releases at output 312 a detection signal conveying the presence of the target object in the receptacle 104.

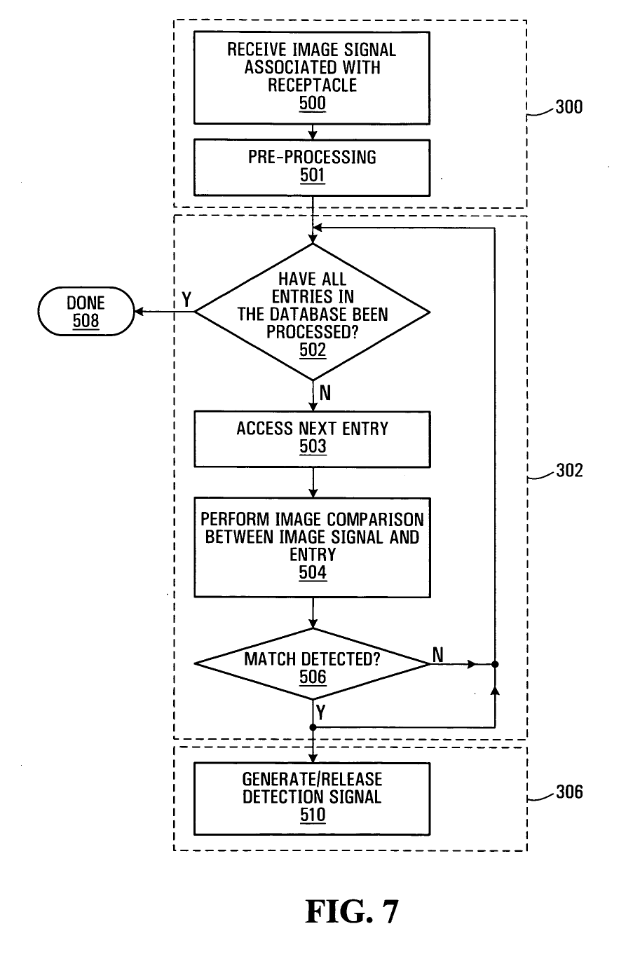

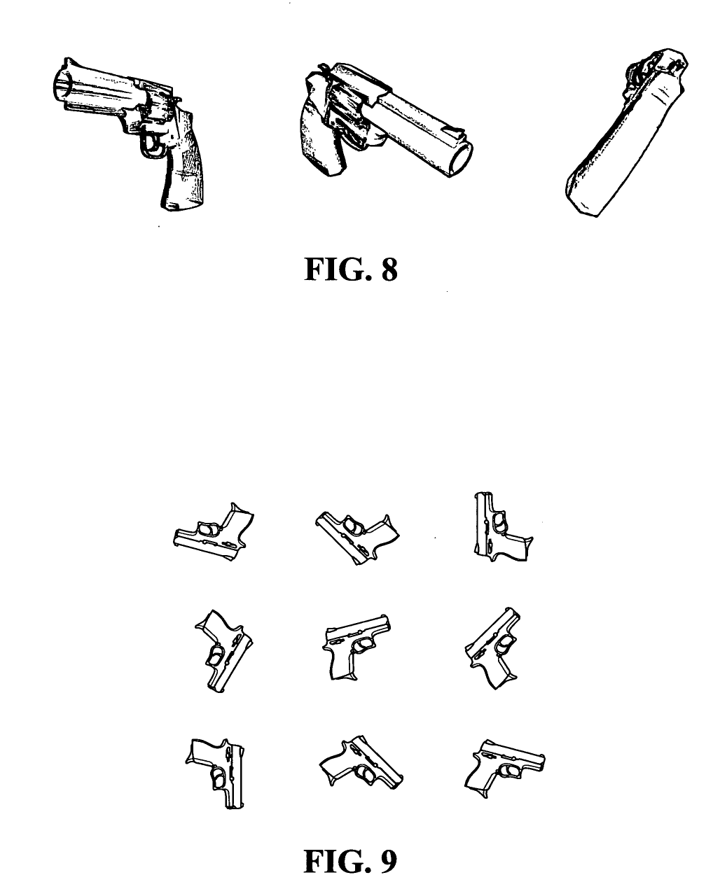

The process implemented by the various functional elements of the processing unit of the apparatus 106 is depicted in FIG. 7 of the drawings. At step 500, the pre-processing module 300 receives an image signal associated with the receptacle 104 via the first input 310. At step 501, the pre-processing module 300 processes the image signal in order to enhance the image, remove extraneous information therefrom and remove noise artefacts in order to obtain more accurate comparison results. The complexity of the requisite level of pre-processing and the related tradeoffs between speed and accuracy depend on the application. Examples of pre-processing may include, without being limited to, brightness and contrast manipulation, histogram modification, noise removal and filtering amongst others. It will be appreciated that all or part of the functionality of the pre-processing module 300 may actually be external to the apparatus 106, e.g., it may be integrated as part of the image generation device 102 or as an external component. It will also be appreciated that the pre-processing module 300 (and hence step 501) may be omitted in certain embodiments of the present invention without detracting from the spirit of the invention. As part of step 501, the pre-processing module 300 releases a modified image signal for processing by the image comparison module 302.

At step 502, the image comparison module 302 verifies whether there remain any unprocessed entries in the database of target objects 110. In the affirmative, the image comparison module 302 proceeds to step 503 where the next entry is accessed and the image comparison module 302 then proceeds to step 504. If at step 502 all entries in the database of target objects 110 have been processed, the image comparison module 302 proceeds to step 508 and the process is completed.

At step 504, the image comparison module 302 compares the image signal associated with the receptacle 104 against the entry accessed at step 503 to determine whether a match exists.

In a specific example of implementation, the comparison performed at step 504 includes effecting a correlation operation between data derived from the image signal and contents of the entries in the database 110, in particular the sub-entries of each entry. In a specific example of implementation, the correlation operation is performed by an optical correlator. A specific example of implementation of an optical correlator suitable for use in comparing two images will be described later on in the specification. In an alternative example of implementation, the correlation operation is performed by a digital correlator.

The image comparison module 302 then proceeds to step 506 where the result of the comparison effected at step 504 is processed to determine whether a match exists between the image signal associated with the receptacle 104 and the entry. In the absence of a match, the image comparison module 302 returns to step 502. In response to detection of a match, the image comparison module 302 triggers the detection signal generation module 306 to execute step 510. Then, the image comparison module 302 returns to step 502 to continue processing with respect to the next entry.

At step 510, the detection signal generation module 306 generates a detection signal conveying the presence of the target object in the receptacle 104, and the detection signal is released at output 312. The detection signal may simply convey the fact that a target object has been detected as present in the receptacle 104, without necessarily specifying the identity of the target object. Alternatively, the detection signal may convey the actual identity of the detected target object detected as being present in the receptacle 104. As previously indicated, the detection signal may include information related to the positioning of the target object within the receptacle 104 and optionally a target object identifier data element associated to the target object determined to be a potential match.

Specific Example of Image Comparison Module 302 Including an Optical Correlator

As mentioned above, in a specific implementation of the image comparison module 302, step 504, which involves a comparison between the image signal associated with the receptacle 104 and the entries of the database of target objects 110, is performed using a correlation operation. The correlation operation may multiply together the Fourier transform of the image signal associated with the receptacle 104 with the Fourier transform complex conjugate of an image of a given target object. The result of the correlation operation provides a measure of the degree of similarity between the two images.

In a specific implementation, the image comparison module 302 includes an optical correlator for computing the correlation between the image signal associated with the receptacle 104 and an entry from the database of target objects 110. Specific examples of implementation of the optical correlator include a joint transform correlator (JTC) and a focal plane correlator (FPC).

The optical correlator multiplies together the Fourier transform of the image signal associated with the receptacle 104 with the Fourier transform complex conjugate of an image of a given target object and records the result with a camera. An energy peak measured with that camera indicates a match between the image signal associated with the receptacle 104 and the image of the given target object.

Advantageously, an optical correlator performs the correlation operation physically through light-based computation, rather than by using software running on a silicon-based computer, which allows computations to be performed at a higher speed than is possible with a software implementation and thus provides for improved real-time performance.

It will be appreciated that the correlation computation may also be implemented using a digital correlator. The correlation operation is computationally intensive and, in certain implementations requiring real-time performance, the use of a digital correlator may not provide a suitable performance. In such implementations, an optical correlator will be preferred.

As described above, the correlation computation is performed between an image associated with the receptacle 104 and the entries of the database of target objects 110, which includes a plurality of entries associated to respective objects that the system 100 is designed to detect. It will be appreciated that the content and format of the database of target objects 110 may vary from one implementation to the next.

The next section describe manners in which the database 110 can be generated when a correlation computation is used to effect a comparison between an images associated with the receptacle 104 and the entries from the database of target objects 110. The skilled person in the art will readily appreciate in light of the present description that other manners for generating the database 110 may be used without detracting from the spirit of the invention.

System for Generating Database of Target Objects 110

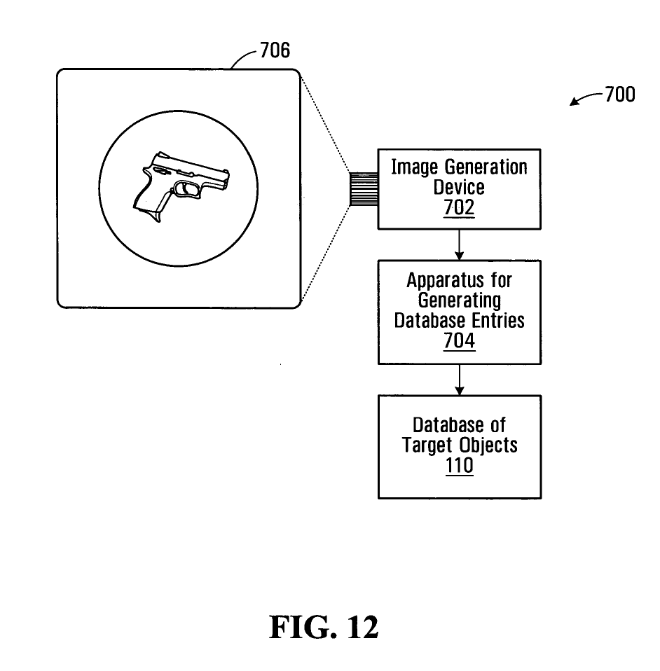

Shown in FIG. 12 is a system 700 for generating entries for the database of target objects 10 suitable for use in screening receptacles to detect the presence of one or more target objects.

As depicted, the system 700 includes an image generation device 702, an apparatus 704 for generating database entries, and optionally a positioning device 706.

The image generation device 702 is suitable for generating image signals associated with a given target object whose presence in a receptacle it is desirable to detect during security screening. The image generation device 702 may be similar to the image generation device 102 described earlier in the specification with reference to FIG. 1 of the drawings.

The apparatus 704 is in communication with the image generation device 702 and with a memory unit storing the database of target objects 110. The apparatus 704 receives at an input the image signals associated with the given target object from the image generation device 702. The apparatus 704 includes a processing unit in communication with the input. The processing unit of apparatus 704 processes the image signals associated with the given target object to generate respective filter data elements. The filter data elements generated are suitable for being processed by a device implementing an optical correlation operation to attempt to detect a representation of the given target object in an image of a receptacle. In a specific example of implementation, the filter data elements are indicative of the Fourier transform (or Fourier transform complex conjugate) of the image associated with the given target object. The filter data elements may also be referred to as templates. Examples of other types of filters that may be generated by the apparatus 704 and the manner in which they may be generated will be described later on in the specification. The filter data elements are then stored in the database of target objects 110 in association with an entry corresponding to the given target object.

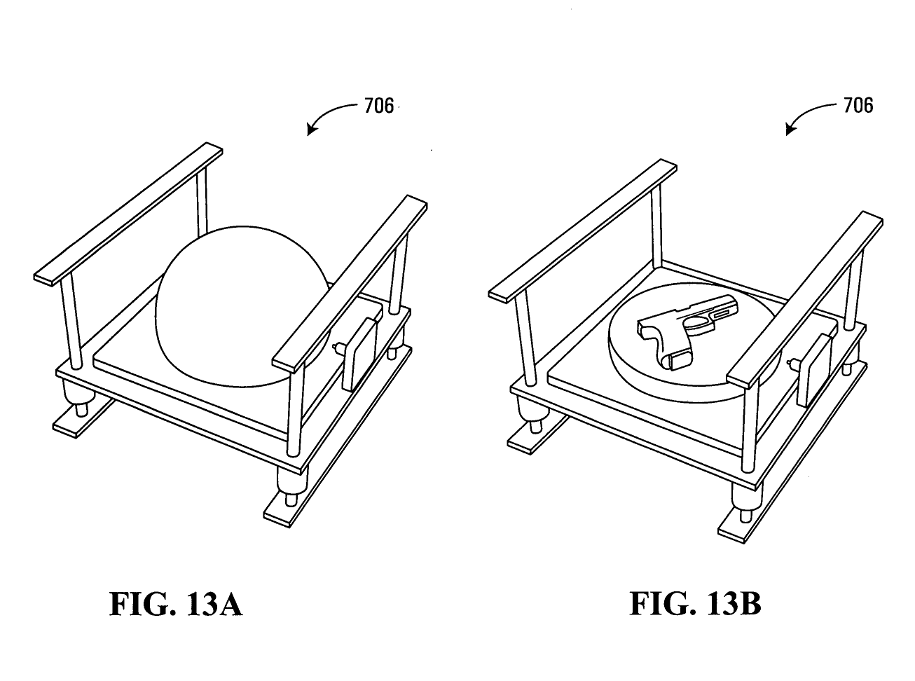

In the embodiment depicted, the system 700 comprises the positioning device 706 for positioning a given target object in two or more distinct orientations such as to allow the image generation device 702 to generate image signals associated with the given target object in each of the two or more distinct orientations. The specific configuration of the positioning device 706 may vary from one implementation to the next and is not critical to the present invention. FIGS. 13a and 13b of the drawings depict a non-limiting example of implementation of the positioning device 706 suitable for use in positioning a given target object in two or more distinct orientations in order to generate image signals associated with the given target object in each of the two or more distinct orientations. As shown in FIG. 13 a, the positioning device 706 is comprised of a hollow spherical housing on which indices identifying various angles are marked to indicate the position of the housing relative to a reference frame. The spherical housing is held in place by a receiving member also including markings to indicate position. The spherical housing and the receiving member are preferably made of a material that is substantially transparent to the image generation device 702 (FIG. 12). For example, where the image generation device 702 is an x-ray machine, the spherical housing and the receiving member are made of a material that appears as being substantially transparent to x-rays. In a non-limiting implementation, the spherical housing and the receiving member are made of a Styrofoam-type material. The spherical housing includes a portion that can be removed in order to be able to position an object within the housing. FIG. 13b shows the positioning device 706 with the removable portion displaced. Inside the hollow spherical housing is provided a transparent supporting structure adapted for holding an object in a suspended manner within the hollow spherical housing. The supporting structure is such that when the removable portion of the spherical housing is repositioned on the other part of the spherical housing, the housing can be rotated in various orientations, thereby imparting those various orientations to the object positioned within the hollow housing. The supporting structure is also made of a material that is transparent to the image generation device 702.

With continued reference to FIG. 12, the apparatus 704 may optionally include a second input (not shown) for receiving supplemental data associated with the given target object and for storing that supplemental information in the database of target objects 110 in connection with an entry associated with the given target object. The second input may be in the form of a data connection to a memory device or of an input device such as a keyboard, mouse, pointer, voice recognition device or any other suitable type of input device. Many types of supplemental information may be provided including, but not limited to:
a) images conveying pictorial information associated to the given target object;
b) a risk level associated with the given target object;
c) a handling procedure associated with the given target object;
d) a dimension associated with the given target object;
e) a weight data element associated with the given target object;
f) a description of the given target object; and
g) a monetary value associated with the given target object.

The manner in which the supplemental data is entered in the database of target objects 110 is not critical to the invention and as such will not be described further here.

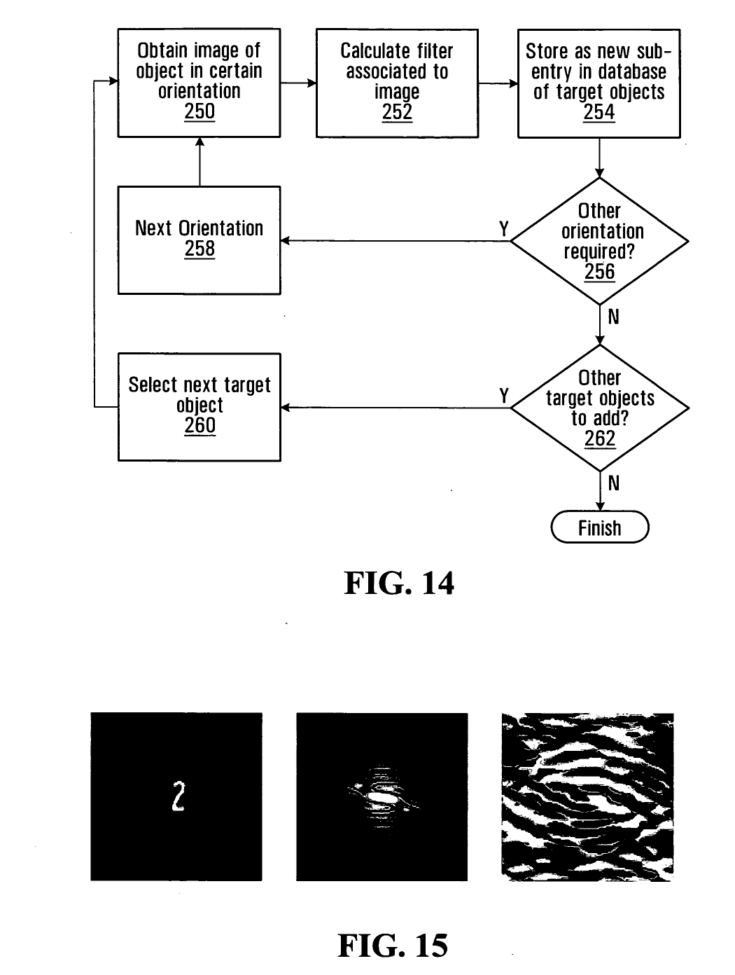

An example of a method for generating an entry in the database of target objects 110 will now be described with reference to FIGS. 12 and 14 of the drawings.

At step 250, an image of a given target object in a given orientation is obtained. The image may have been pre-stored on a computer readable medium and in that case obtaining the image of the given target object in a given orientation involves extracting data corresponding to the image of a given target object in a given orientation from that computer readable medium. Alternatively, at step 250 a given target object is positioned in a certain orientation on the positioning device 706 in the viewing field of the image generation device 702 and an image of the given target object is then obtained by the image generation device 702.

At step 252, the image of the given target object in a given orientation obtained at step 250 is processed by the apparatus 704 to generate a corresponding filter data element. As previously indicated, the filter data element generated is suitable for being processed by a processing unit implementing an optical correlation operation to attempt to detect a representation of the given target object in an image of a receptacle.

At step 254, a new sub-entry associated to the given target object is created in the database of target objects 110 and the filter data element generated at step 252 is stored as part of that new sub-entry. Optionally, the image of the given target object in the given orientation obtained at step 250 is also stored as part of the new sub-entry.

At step 256, it is determine whether another image of the given target object in a different orientation is required. The requirements may be generated automatically (i.e. there is a pre-determined number of orientations required for that target object or for all target objects) or may be provided by a user using an input control device.

If another image of the given target object in a different orientation is required, step 256 is answered in the affirmative and the system proceeds to step 258. At step 258, the next orientation is selected, leading to step 250 where an image of the given target object in the next orientation is obtained. The image of the next orientation may have been pre-stored on a computer readable medium and in that case selecting the next orientation at step 258 involves locating the corresponding data on the computer readable storage medium. Alternatively, at step 258 the next orientation of the given target object is determined.

If no other image of the given target object in a different orientation is required, step 256 is answered in the negative and the system proceeds to step 262. At step 262, it is determined whether there remains any other target objects to be processed. If there remains other target objects to be processed, step 262 is answered in the affirmative and the system proceeds to step 260 where the next target object is selected and then to step 250 where an image of the next target object in a given orientation is obtained. If at step 262 there are no other target objects that remain to be processed, step 262 is answered in the negative and the process is completed. Optionally, step 262 may be preceded by an additional step (not shown) including storing supplemental data in the database of target objects 110 in association with the entry corresponding to the given target object.

It will be readily apparent to the person skilled in the art in light of the present description that the order of the steps presented above may vary in certain implementations without detracting from the spirit of the invention.

As indicated above with reference to step 250, the images of the target objects may have been obtained and pre-stored on a computer readable medium prior to the generation of the entries for the database of target objects 110 and of the filter data elements. In such a case, and alternatively stated, step 250 may be preceded by another step (not shown in the figures). This other step would include obtaining a plurality of images of the given target object by sequentially positioning the given target object in different orientations and obtaining an image of the given target object for each of the different orientations using the image generating device 702. These images would then be stored on a computer readable storage medium.

Once the database of target objects 110 has been created by a process such as the example process depicted in FIG. 14, it can be incorporated into a system such as the system 100 shown in FIG. 1 and used to detect the presence of one or more target objects in a receptacle. The database of target objects 110 may be provided as part of such a system or may be provided as a separate component to the system or as an update to an already existing database of target objects.

Therefore, the example process depicted in FIG. 14 may further include the step (not shown) of providing the contents of the database of target objects 110 to a facility including a security screening station for use in detecting in a receptacle the presence of one or more target objects from the database of target objects 110. The facility may be located in a variety of places including, but not limited to, an airport, a mail sorting station, a border crossing, a train station and a building. Alternatively, the example process depicted in FIG. 14 may further include the step (not shown) of providing the contents of the database of target objects 110 to a customs station for use in detecting in a receptacle the presence of one or more target objects from the database of target objects 110.

Filter Generation

As described above, the apparatus 704 (shown in FIG. 12) is adapted for processing an image of a given target object in a given orientation to generate a corresponding filter data element.

Optionally, image processing and enhancement can be performed on the original image of the target object to obtain better matching performance depending on the environment and application.

In a specific example of implementation, the generation of the reference template or filter data element is performed in a few steps. First, the background is removed from the image of the given target object. In other words, the image is extracted from the background and the background is replaced by a black background. The resulting image is then processed through a Fourier transform function. The result of this transform is a complex image. The resulting Fourier transform (or its complex conjugate) may then be used as the filter corresponding to the image of the given target object.

Alternatively, the filter may be derived on the basis of a function of a Fourier transform of the image of the given target object in the certain orientation. For example, a phase only filter (POF) may be generated by the apparatus 704. A phase only filter (POF) only contains the complex conjugate of the phase information (between zero and 2π) which is mapped to a 0 to 255 range values. These 256 values correspond in fact to the 256 levels of gray of an image. The person skilled in the art, in light of the present specification, will readily appreciate that various other types of templates or filters can be generated. Many methods for generating Fourier filters are known in the art and a few such methods will be described later on in the specification. The reader is invited to refer to the following document for additional information regarding phase only filters (POF): “Phase-Only Matched Filtering”, Joseph L. Horner and Peter D. Gianino, Appl. Opt. Vol. 23 no. 6, 15 Mar. 1994, pp. 812-816. The contents of this document are incorporated herein by reference.

As a variant, the filter may be derived on the basis of a function of a Fourier transform of a composite image, the composite image including a component derived from the given target object in the certain orientation. For example, in order to reduce the amount of data needed to represent the whole range of 3D orientations that a single target object can take, the apparatus 704 may be operative for generating a MACE (Minimum Average Correlation Energy) filter used to generate a template or filter for a given target object.

Typically, the MACE filter combines several different 2D projections of a given object and encodes them in a single MACE filter instead of having one 2D projection per filter. One of the benefits of using MACE filters is that the resulting database of target objects 110 would take less space since it would include fewer items. Also, since the number of correlation operations needed to identify a single target object would be reduced, the total processing time to determine whether a given object is present would also be reduced. The reader is invited to refer to the following document for additional information regarding MACE filters: Mahalanobis, A., B. V. K. Vijaya Kumar, and D. Casasent (1987); Minimum average correlation energy filters, Appl. Opt. 26 no. 17, 3633-3640. The contents of this document are incorporated herein by reference.

In yet another alternative implementation, the apparatus 704 may be adapted to generate a mosaic filter. More specifically, a way of reducing the processing time of the correlation computation is to take advantage of the linear properties of the Fourier transform. By dividing the target image into several sub-images, a composite image can be formed, herein referred to as a mosaic. When a mosaic is displayed at the input of the correlator, the correlation is computed simultaneously on all the sub-images without incurring any substantial time penalty. A mosaic may contain several different target objects or several different orientations of the same target object or a combination of both. FIG. 9 of the drawings depicts a mosaic of a target object in various orientations and scales. The parallel processing capabilities of a mosaic effectively increase the throughput of an optical correlator. The reader is invited to refer to the following document for additional information regarding the use of a mosaic in an optical correlator: Method and apparatus for evaluating a scale factor and a rotation angle in image processing, Alain Bergeron et al., U.S. Pat. No. 6,549,683, Apr. 15, 2003. The contents of this document are incorporated herein by reference.

It will be readily appreciated that the apparatus 704 may generate other suitable types of filters and that such alternative filters will become apparent to the person skilled in the art in light of the present description.

Fourier Transform and Spatial Frequencies

The Fourier transform as applied to images will now be described in general terms. The Fourier transform is a mathematical tool used to convert the information present within an object's image into its frequency representation. In short, an image can be seen as a superposition of various spatial frequencies and the Fourier transform is a mathematical operation used to compute the intensity of each of these frequencies within the original image. The spatial frequencies represent the rate of variation of image intensity in space. Consequently, a smooth or uniform pattern mainly contains low frequencies. Sharply contoured patterns, by contrast, exhibit a higher frequency content.

The Fourier transform of an image f(x,y) is given by:

$$F ( u , v ) = \int \int f ( x , y ) {ⅇ}^{- j2π ( ux + vy )} ⅆ x ⅆ y \qquad ( 1 )$$

where u, v are the coordinates in the frequency domain. Thus, the Fourier transform is a global operator: changing a single frequency of the Fourier transform affects the whole object in the spatial domain.

A correlation operation can be mathematically described by:

$$C ( ɛ , ξ ) = {\int }_{- ∞}^{∞} {\int }_{- ∞}^{∞} f ( x , y ) {h}^{*} ( x - ɛ , y - ξ ) ⅆ x ⅆ y \qquad ( 2 )$$

where ε and ξ represent the pixel coordinates in the correlation plane, C(ε,ξ) stands for the correlation, x and y identify the pixel coordinates of the input image, f(x, y) is the original input image and h*(ε,ξ) is the complex conjugate of the correlation filter.

In the frequency domain the same expression takes a slightly different form:
C(ε,ξ)=ℑ⁻¹(F(u,v)H*(u,v)) (3)
where ℑ is the Fourier transform operator, u and v are the pixel coordinates in the Fourier plane, F(u,v) is the Fourier transform complex conjugate of the image acquired with the camera f(x,y) and H*(u,v) is the Fourier transform of the filter of the reference template. Thus, the correlation between an input image and a target template is equivalent, in mathematical terms, to the multiplication of their respective Fourier transform, provided that the complex conjugate of the filter is used. Consequently, the correlation can be defined in the spatial domain as the search for a given pattern (template), or in the frequency domain, as filtering operation with a specially designed matched filter.

Advantageously, the use of optics for computing a correlation operation allows the computation to be performed in a shorter time than by using a digital implementation of the correlation. It turns out that an optical lens properly positioned (i.e. input and output images are located on the lens's focal planes) automatically computes the Fourier transform of the input image. In order to speed up the computation of the correlation, the Fourier transform of an image of a target object can be computed beforehand and submitted to the correlator as a mask or template. The target template (or filter in short) is generated by computing the Fourier transform of the reference template. This type of filter is called a matched filter.

FIG. 15 depicts the Fourier transform of the spatial domain image of a ‘2’. It can be seen that most of the energy (bright areas) is contained in the central portion of the Fourier transform image which correspond to low spatial frequencies (the images are centered on the origin of the Fourier plane). The energy is somewhat more dispersed in the medium frequencies and is concentrated in orientations representative of the shape of the input image. Finally, little energy is contained in the upper frequencies. The right-hand-side image shows the phase content of the Fourier transform. The phase is coded from black (0°) to white (360°).

Generation of Filters from Images

Matched filters, as their name implies, are specifically adapted to respond to one image in particular: they are optimized to respond to an object with respect to its energy content. Generally, the contour of an object corresponds to its high frequency content. This can be easily understood as the contour represent areas where the intensity varies rapidly (hence a high frequency).

In order to emphasize the contour of an object, the matched filter can be divided by its module (the image is normalized), over the whole Fourier transform image. The resulting filter is called a Phase-Only Filter (POF) and is defined by:

$$POF ( u , v ) = \frac{{H}^{*} ( u , v )}{\vert {H}^{*} ( u , v ) \vert} \qquad ( 4 )$$

The reader is invited to refer to the following document for additional information regarding phase only filters (POF): “Phase-Only Matched Filtering”, Joseph L. Horner and Peter D. Gianino, Appl. Opt. Vol. 23 no. 6, 15 Mar. 1994, pp. 812-816. The contents of this document are incorporated herein by reference.

Because these filters are defined in the frequency domain, normalizing over the whole spectrum of frequencies implies that each of the frequency components is considered with the same weight. In the spatial domain (e.g. usual real-world domain), this means that the emphasis is given to the contours (or edges) of the object. As such, the POF filter provides a higher degree of discrimination, sharper correlation peaks and higher energy efficiency.

The discrimination provided by the POF filter, however, has some disadvantages. It turns out that, although the optical correlator is somewhat insensitive to the size of the objects to be recognized, the images are expected to be properly sized, otherwise the features might not be registered properly. To understand this requirement, imagine a filter defined out of a given instance of a ‘2’. If that filter is applied to a second instance of a ‘2’ whose contour is slightly different, the correlation peak will be significantly reduced as a result of the great sensitivity of the filter to the original shape. A different type of filter, termed a composite filter, was introduced to overcome these limitations. The reader is invited to refer to the following document for additional information regarding this different type of composite filter: H. J. Caufield and W. T. Maloney, Improved discrimination in optical character recognition, Appl. Opt., 8, 2354, 1969. The contents of this document are incorporated herein by reference.

In accordance with specific implementations, filters can be designed by:
appropriately choosing one specific instance (because it represents characteristics which are, on average, common to all symbols of a given class) of a symbol and calculating from that image the filter against which all instances of that class of symbols will be compared; or
averaging many instances of a given to create a generic or ‘template’ image from which the filter is calculated. The computed filter is then called a composite filter since it incorporates the properties of many images (note that it is irrelevant whether the images are averaged before or after the Fourier transform operator is applied, provided that in the latter case, the additions are performed taking the Fourier domain phase into account).

The latter procedure forms the basis for the generation of composite filters. Thus composite filters are composed of the response of individual POF filters to the same symbol. Mathematically, this can be expressed by:
h_{comp}(x,y)=αₐhₐ(x,y)+α_{b}h_{b}(x,y)+K+αₓhₓ(x,y) (5)

A filter generated in this fashion is likely to be more robust to minor signature variations as the irrelevant high frequency features will be averaged out. In short, the net effect is an equalization of the response of the filter to the different instances of a given symbol.

Composite filters can also be used to reduce the response of the filter to the other classes of symbols. In equation (5) above, if the coefficient b, for example, is set to a negative value, then the filter response to a symbol of class b will be significantly reduced. In other words, the correlation peak will be high if hₐ(x,y) is at the input image, and low if h_{b}(x,y) is present at the input. A typical implementation of composite filters is described in: Optical character recognition (OCR) in uncontrolled environments using optical correlators, Andre Morin, Alain Bergeron, Donald Prevost, and Ernst A. Radloff Proc. SPIE Int. Soc. Opt. Eng. 3715, 346 (1999). The contents of this document are incorporated herein by reference.

Receptacle Screening System with Optical Correlator

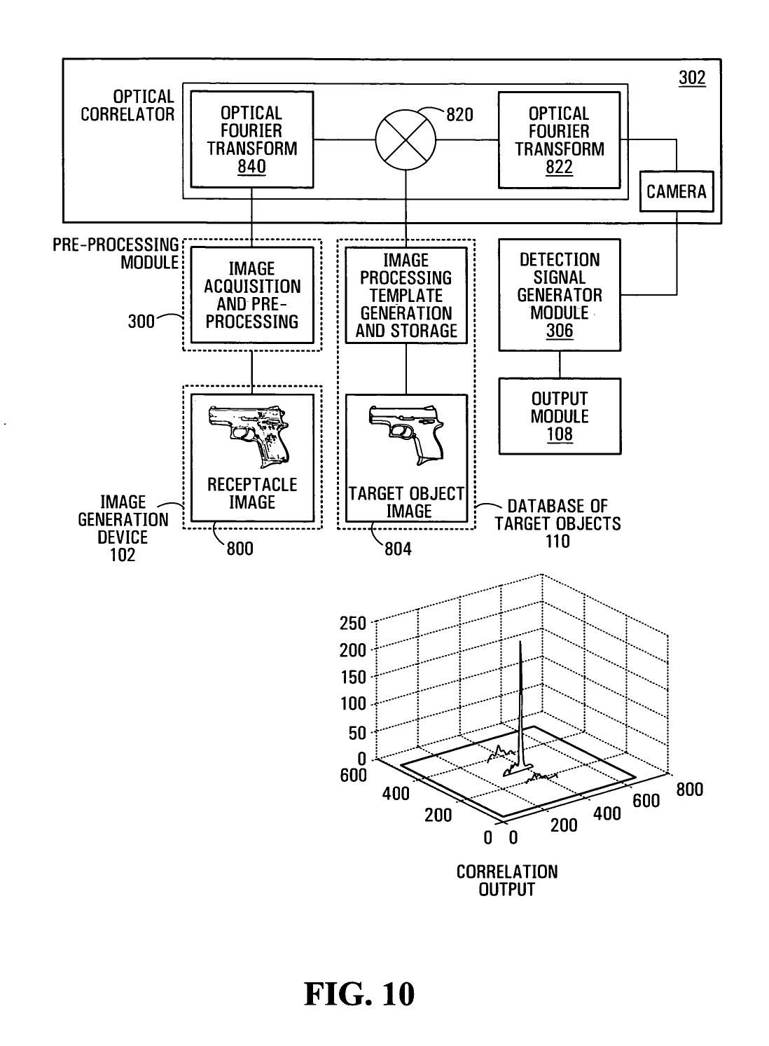

FIG. 10 depicts a high level functional block diagram of an example of a receptacle screening system using an optical correlator as part of the image comparison module 302 (FIG. 6). As shown, an image 800 associated with a receptacle is generated by the image generation device 102 and provided as input to the pre-processing module 300. The pre-processing module 300 performs image acquisition and pre-processing operations and forwards the pre-processed signal to the optical correlator, which is part of the image comparison module 302. At the optical correlator, the pre-processed image undergoes an optical Fourier transformation 840. The result of the transformation is multiplied 820 by the (previously computed) Fourier transform complex conjugate of an image 804 of a given target object obtained from the database of target objects 110. The optical correlator then processes the result of the multiplication of the two Fourier transforms by applying another optical Fourier transform 822. The resulting signal is captured by a camera at what is referred to as the correlation plane, which yields the correlation output. The correlation output is released for transmission to the detection signal generator 306 where it is analyzed. A peak in the correlation output indicates a match between the image 800 associated with the receptacle 104 and the image 804 of the given target object. The result of the processing is then conveyed to the user by output module 108.

In a non-limiting example of implementation of an optical correlator, the Fourier transform of the image 800 associated with the receptacle 104 is performed as follows. The image is displayed internally on a small Liquid Crystal Display (LCD). A collimated coherent light beam projects the image through a lens that performs the equivalent of a Fourier transform on the image. The multiplication 820 of the Fourier transform of the image 800 by the (previously computed) Fourier transform complex conjugate of the image 804 of a given target object is performed by projecting the Fourier transform of the image 800 on a second LCD screen on which is displayed the template or filter associated to the image 804. The two multiplied Fourier transforms are then processed through a second Fourier lens, which forces the light beam image to a CCD (camera) at the correlation plane. The CCD output is then sent to the detection signal generator module 306. In a specific implementation, the detection signal generator module 306 includes a frame grabber implemented by a digital computer. The digital computer is programmed to detect correlation peaks captured by the CCD.

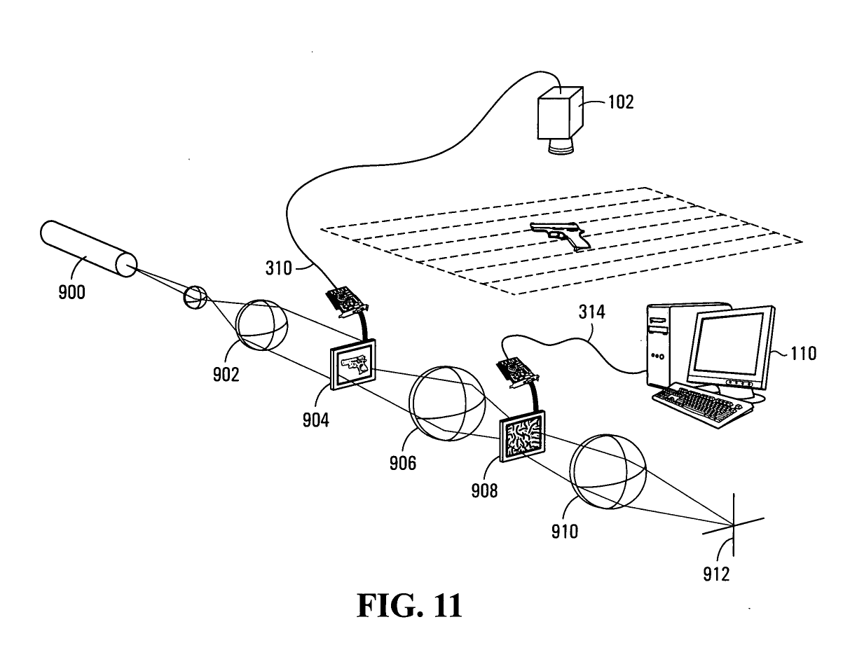

The inner workings of the aforementioned non-limiting example optical correlator are illustrated in FIG. 11. On the left hand side appears a laser source 900 that generates a coherent light beam used to project images across the correlator. The light beam is directed first through a small set of lenses 902 used to expand its diameter in order to illuminate, in parallel, the whole surface of a first LCD screen 904. The image 800 associated with the receptacle 104 is displayed on the first LCD screen 904 either through a direct camera interface or provided as a VGA image by a computing device. The first LCD screen 904 is illuminated by the light beam and the image is propagated through the correlator. In the illustrated example, the captured image 800 is that of a gun on a conveyor belt.

The light beam modulated by the first image on the first LCD screen 904 is then propagated through a second set of lenses 906, referred to as a Fourier lens since it performs the equivalent of the Fourier transform mathematical operation. The inherent properties of light are used to physically perform the appropriate calculations. Specifically, the propagation of light is a function which corresponds to the kernel of the Fourier transform operation, thus the propagation of light along the axis of a Fourier lens represents a sufficiently strong approximation of this natural phenomenon to assert that the light beam undergoes a Fourier transform. Otherwise stated, a lens has the inherent property of performing a Fourier transform on images observed at its front focal plane, provided that this image is displayed at its back focal plane. The Fourier transform, which can normally be rather computation-intensive when calculated by a digital computer, is performed in the optical correlator simply by the propagation of the light. The mathematics behind this optical realization is equivalent to the exact Fourier transform function and can be modeled with standard fast Fourier algorithms. For more information regarding Fourier transforms, the reader is invited to consider B. V. K. Vijaya Kumar, Marios Savvides, Krithika Venkataramani, and Chunyan Xie, “Spatial frequency domain image processing for biometric recognition”, Biometrics ICIP Conference 2002 or alternatively J. W. Goodman, Introduction to Fourier Optics, 2nd Edition, McGraw-Hill, 1996. The contents of these documents are incorporated herein by reference.

After going through the Fourier lens 906, the signal is projected on a second LCD screen 908 on which is displayed the template (or filter), i.e., the Fourier transform of the image of the given target object. When the Fourier transform of the image associated with the receptacle goes through the second LCD screen 908 on which the template is displayed, the light beam crosses a second Fourier lens 910 which, again, optically computes the equivalent of a Fourier transform multiplication. This operation corresponds to a correlation in the spatial domain. The image displayed on the second LCD screen 908 in fact induces a phase variation on the incoming light beam. Each pixel can potentially induce a phase change whose magnitude is equivalent to its gray level. As such the Fourier transform displayed on the first LCD screen 904 is multiplied with the Fourier transform of the image of the given target object, which is equivalent to performing a correlation.

The second Fourier lens 910 finally concentrates the light beam on a small area camera or CCD 912 where the result of the correlation is measured, so to speak. The CCD (camera) 912 in fact measures energy peaks on the correlation plane. The position of a correlation peak corresponds in fact to the location of the target object center in the image 800 associated with the receptacle.

Referring back to FIG. 10, the CCD (or camera) communicates the signal from the optical correlator to the detection signal generator module 306. In this specific implementation, the detection signal generator module 306 is a computing unit including a frame grabber and software. The software is adapted to process the signal received from the correlator to detect energy peaks as gray level video signals varying between 0 and 255. A strong intensity peak on the correlation plane indicates a match between the image 800 associated with the receptacle and the image 804 of the given target object.

The location of the energy peak also indicates the location of the center of the target object in the image 800 associated with the receptacle.

The detection signal generator module 306 generates a detection signal. The detection signal may provide, for example, information about the level of the peak(s) and, optionally, the position of the peak(s). The detection signal may also include data allowing identification of the target object for which the level of the peak(s) and, optionally, the position of the peak(s) is being provided.

### Second Embodiment

### Cargo Container Screening

Although the above-described screening system was described in connection with screening of receptacles generally, the concepts described above can readily be adapted in applications dedicated to specific types of receptacles such as cargo containers, for example.

For instance, in an alternative embodiment, a system for screening cargo containers is provided. The system includes components similar to those described in connection with the system 100 depicted in FIG. 1. In a specific example of implementation, the image generation device 102 is configured to scan a large object (i.e. the cargo container) and possibly to scan the large object along various axes to generate multiple images associated to the cargo container. The image or images associated with the cargo container convey information related to the contents of the cargo container. Any suitable method for generating images associated to containers may be used. Such scanning methods for large objects are known in the art and as such will not be described further here. Each image is then processed in accordance with the method described in the present specification to detect the presence of target objects in the cargo container.

### Third Embodiment

### Screening of Persons

While the above-described screening system was described in connection with screening of receptacles, the concepts described above can also be applied to the screening of people.

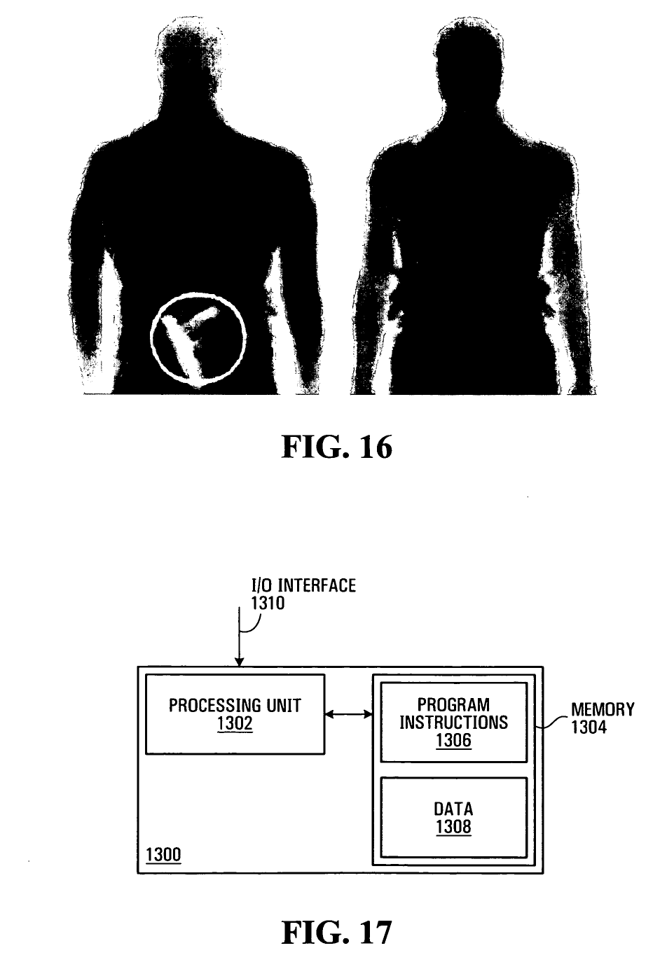

For example, in an alternative embodiment, a system for screening people is provided. The system includes components similar to those described in connection with the system 100 depicted in FIG. 1. In a specific example of implementation, the image generation device 102 is configured to scan a person and possibly to scan the person along various axes to generate multiple images associated to the person. The image or images associated with the person convey information related to the objects carried by the person. FIG. 16 depicts two images associated with a person suitable for use in connection with a specific implementation of the system. Each image is then processed in accordance with the method described in the present specification to detect the presence of target objects on the person.

Example of Specific Physical Implementation

Certain portions of various components described herein, such as the image processing apparatus 106 (FIG. 1), the apparatus 704 for generating database entries (FIG. 12), the database of target objects 110, and the output module 108, may each be implemented on one or more general purpose digital computers such as a general purpose digital computer 1300 depicted in FIG. 17. The general purpose digital computer 1300 includes a processing unit 1302 and a memory 1304 connected by a communication bus. The memory includes data 1308 and program instructions 1306. The processing unit 1302 is adapted to process the data 1308 and the program instructions 1306 in order to implement functionality described in the specification and depicted in the drawings. The digital computer 1300 may also comprise an I/O interface 1310 for receiving or sending data elements to external devices.

As a possible variant, the image processing apparatus 106 and possibly other components described herein may be implemented on a dedicated hardware platform where electrical/optical components implement functionality described in the specification and depicted in the drawings. Specific implementations may be realized using ICs, ASICs, DSPs, FPGA, an optical correlator, a digital correlator or other suitable hardware elements.

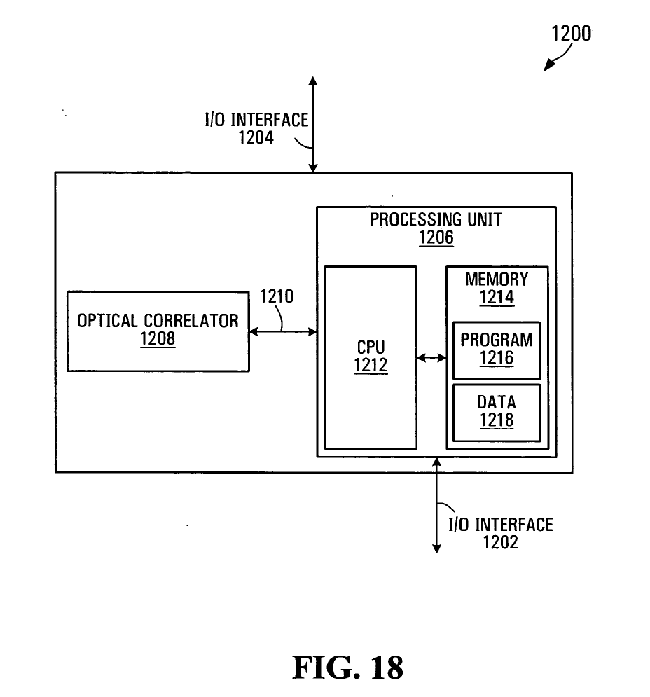

Other alternative implementations of the image processing apparatus 106 may be implemented as a combination of dedicated hardware and software such as apparatus 1200 depicted in FIG. 18. As shown, such an implementation comprises an optical correlator 1208 or other dedicated image processing hardware and a general purpose computing unit 1206 including a CPU 1212 and a memory 1214 connected by a communication bus. The memory includes data 1218 and program instructions 1216. The CPU 1212 is adapted to process the data 1218 and the program instructions 1216 in order to implement functionality described in the specification and depicted in the drawings. The CPU 1212 is also adapted to exchange data with the optical correlator 1208 over communication link 1210 to make use of the optical correlator's image processing capabilities. The apparatus 1202 may also comprise I/O interfaces 1202 1204 for receiving or sending data elements to external devices.

In a variant, a single optical correlator 1208 can be shared by multiple general purpose computing units 1206. In such a variant, conventional parallel processing techniques can be used for sharing a common hardware resource.

In a specific example of implementation, the optical correlator suitable for use in the system described includes two video inputs. The video inputs are suitable for receiving a signal derived from an image generation device and a signal derived from a database of target objects. In a specific implementation, the video inputs are suitable for receiving a signal in an NTSC compatible format or a VGA compatible format. It will be appreciated that either one of the video inputs may be adapted for receiving signals of lower or higher resolution than the VGA compatible format signal. Similarly, it will also be appreciated that the video input suitable for receiving a signal in an NTSC compatible format may be adapted for receiving signals in suitable formats such as, but not limited to, PAL and SECAM. In a non-limiting implementation, the optical correlator is adapted to process an image received at the video input having an area of 640×480 pixels. However, it will be readily apparent that, by providing suitable interfaces, larger or smaller images can be handled since the optical correlator's processing capability is independent of the size of the image, as opposed to digital systems that require more processing time and power as images get larger.

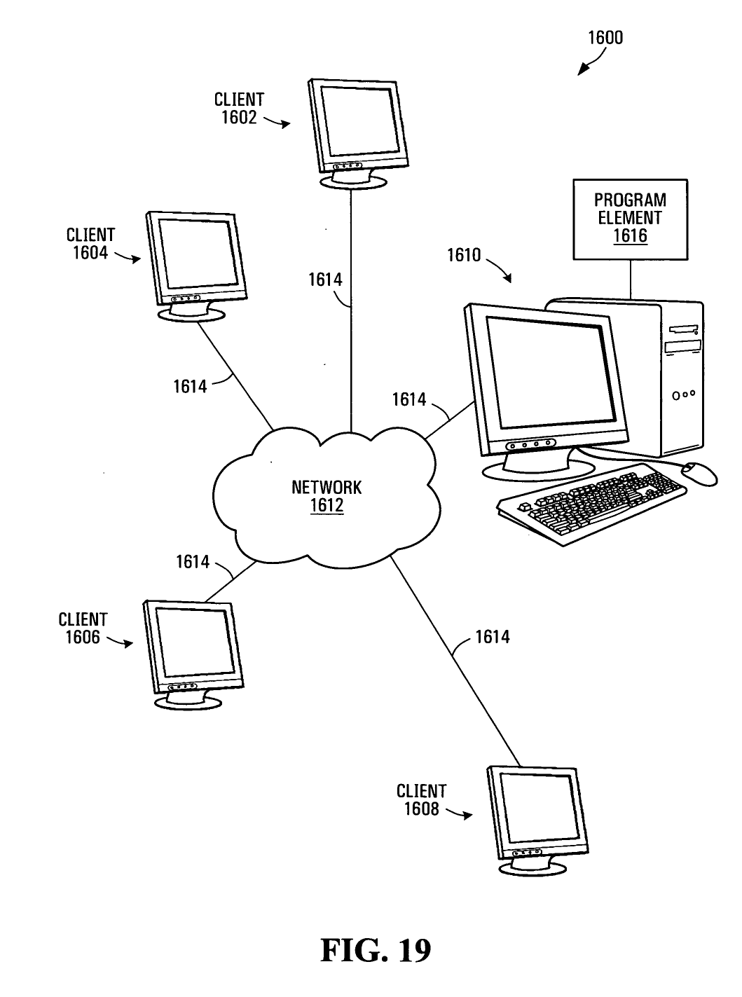

It will be appreciated that the system 100 depicted in FIG. 1 may also be of a distributed nature where image signals associated with receptacles are obtained at one or more locations and transmitted over a network to a server unit implementing the method described above. The server unit may then transmit a signal for causing an output unit to display information to the user. The output unit may be located in the same location where the image signal associated with the receptacle was obtained or in the same location as the server unit or in yet another location. In a non-limiting implementation, the output unit is part of a centralized receptacle screening facility. FIG. 19 illustrates an example of a network-based client-server system 1600 for screening receptacles. The client-server system 1600 includes a plurality of client systems 1602, 1604, 1606 and 1608 connected to a server system 1610 through network 1612. Communication links 1614 between the client systems 1602, 1604, 1606 and 1608 and the server system 1610 may be metallic conductors, optical fibres or wireless, without departing from the spirit of the invention. The network 1612 may be any suitable network including but not limited to a global public network such as the Internet, a private network and a wireless network. The server system 1610 may be adapted to process and issue signals concurrently using suitable methods known in the computer related arts.

The server system 1610 includes a program element 1616 for execution by a CPU. Program element 1616 includes functionality to implement the methods described above and includes the necessary networking functionality to allow the server system 1610 to communicate with the client systems 1602, 1604, 1606 and 1608 over network 1612. In a specific implementation, the client systems 1602, 1604, 1606 and 1608 include display units responsive to signals received from the server system 1610 for displaying information to viewers of these display units. Optionally, the server system 1610 may also include an optical correlator unit.

Although the present invention has been described in considerable detail with reference to certain embodiments thereof, variations and refinements are possible without departing from the spirit of the invention. Therefore, the scope of the invention should be limited only by the appended claims and their equivalents.

1. A computer readable storage medium storing a database of target objects suitable for use in detecting the presence of one or more target objects in a receptacle, said database of target objects comprising:
a) a plurality of entries, each entry being associated to a respective target object whose presence in a receptacle it is desirable to detect during security screening;
b) an entry for a given target object comprising a group of sub-entries, each sub-entry being associated to the given target object in a respective orientation;
c) at least part of each sub-entry being suitable for being processed by a processing unit implementing an optical correlation operation to attempt to detect a representation of the given target object in an image of the receptacle.

2. A computer readable storage medium as defined in claim 1, wherein the group of sub-entries in the entry for the given target object are first information, the entry for the given target object including second information suitable for being processed by a computing apparatus to derive a pictorial representation of the given target object.

3. A computer readable storage medium as defined in claim 1, wherein each sub-entry in the group of sub-entries includes a component indicative of a filter, the filter being derived on the basis of an image of the given target object in a certain orientation.

4. A computer readable storage medium as defined in claim 3, wherein the filter is indicative of a Fourier transform of the image of the given target object in the certain orientation.

5. A computer readable storage medium as defined in claim 3, wherein the filter is indicative of an image of a Fourier transform of the image of the given target object in the certain orientation.

6. A computer readable storage medium as defined in claim 3, wherein the filter is derived on the basis of a function of a Fourier transform of the image of the given target object in the certain orientation.

7. A computer readable storage medium as defined in claim 3, wherein the filter is derived on the basis of a function of a Fourier transform of a composite image, the composite image including a component derived from the given target object in the certain orientation.

8. A computer readable storage medium as defined in claim 3, wherein the component indicative of the filter is a first component, each sub-entry in the group of sub-entries including a second component indicative of an image of the given target object in the certain orientation.

9. A computer readable storage medium as defined in claim 1, wherein said group of sub-entries includes four or more sub-entries.

10. A computer readable storage medium as defined in claim 1, wherein the entry for the given target object comprises third information associated with the given target object, the third information conveying at least one of:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

11. A computer readable storage medium as defined in claim 1, further comprising a program element adapted to interact with the database of target objects, said program element when executed by a processor being responsive to a query signal requesting information associated to a certain target object for:
a) locating in the database of target objects an entry corresponding to the certain target object;
b) extracting information from the entry corresponding to the certain target object on the basis of the query signal;
c) releasing a signal conveying the information extracted in b) for transmission to an entity distinct from the database of target objects.

12. A method for generating an entry in a database of target objects suitable for use in detecting the presence of one or more target objects in a receptacle, said method comprising:
a) obtaining a plurality of images of a given target object whose presence in a receptacle it is desirable to detect during security screening, each image of the given target object in the plurality of images corresponding to the given target object in a respective orientation;
b) processing each image in the plurality of images to generate respective filter data elements, the filter data elements being suitable for being processed by a processing unit implementing an optical correlation operation to attempt to detect a representation of the given target object in an image of a receptacle;
c) storing the filter data elements in the database of target objects in association with an entry corresponding to the given target object.

13. A method as defined in claim 12, wherein obtaining a plurality of images of the given target object comprises sequentially positioning and obtaining an image of the given target object in orientations selected from a set of orientations.

14. A method as defined in claim 12, wherein at least some images in said plurality of images of the given target object are derived on the basis of penetrating radiation.

15. A method as defined in claim 14, wherein at least some images in said plurality of images of the given target object are x-ray images.

16. A method as defined in claim 12, wherein at least some images in said plurality of images of the given target object are derived on the basis of emitted radiation.

17. A method as defined in claim 12, wherein said method comprises computing Fourier transforms associated to the respective images in the plurality of images of the given target object.

18. A method as defined in claim 17, said method comprises storing in the database of target objects data conveying images of the Fourier transforms in association with the entry corresponding to the given target object.

19. A method as defined in claim 17, said method comprises storing data conveying the plurality of images of the given target object in association with the entry corresponding to the given target object.

20. A method as defined in claim 17, wherein said plurality of images of the given target object includes 4 or more images.

21. A method as defined in claim 12, wherein said method comprises storing supplemental data in association with the entry corresponding to the given target object, at least part of said supplemental data being suitable for being processed to derive an image conveying pictorial information associated to the given target object.

22. A method as defined in claim 12, said method comprising storing supplemental data in association with the entry corresponding to the given target object, said supplemental data conveying at least one of:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

23. A method as defined in claim 12, wherein said method comprises providing the contents of said database of target objects to a facility including a security screening station for use in detecting in a receptacle the presence of one or more target objects from the database of target objects.

24. A method as defined in claim 12, wherein said method comprises providing the contents of said database of target objects to a customs station for use in detecting in a receptacle the presence of one or more target objects from the database of target objects.

25. A method as defined in claim 23, wherein the facility including the security screening station is located in an airport.

26. A method as defined in claim 23, wherein the facility including the security screening station is located in a mail sorting station.

27. A method as defined in claim 23, wherein the facility including the security screening station is located at a border crossing.

28. A method as defined in claim 23, wherein the facility including the security screening station is located at either one of a train station and a building.

29. A computer readable storage medium storing a program element suitable for execution by a computing apparatus for generating an entry in a database of target objects suitable for use in detecting the presence of one or more target objects in a receptacle, said computing apparatus comprising:
a) a memory unit for storing a plurality of images of a given target object whose presence in a receptacle it is desirable to detect during security screening, each image of the given target object in the plurality of images corresponding to the given target object in a respective orientation;
b) a processor operatively connected to said memory unit, said program element when executing on said processor being operative for:
i) processing each image in the plurality of images to generate respective filter data elements, the filter data elements being suitable for being processed by a processing unit implementing an optical correlation operation to attempt to detect a representation of the given target object in an image of a receptacle;
ii) storing the filter data elements in the database of target objects in association with an entry corresponding to the given target object.

30. A computer readable storage medium as defined in claim 12, wherein said program element when executing on said processor is operative for:
a) receiving the plurality of images of the given target object whose presence in a receptacle it is desirable to detect during security screening;
b) storing said plurality of images on the memory unit of the computing apparatus.

31. A computer readable storage medium as defined in claim 29, wherein at least some images in said plurality of images of the given target object are derived on the basis of penetrating radiation.

32. A computer readable storage medium as defined in claim 31, wherein at least some images in said plurality of images of the given target object are x-ray images.

33. A computer readable storage medium as defined in claim 29, wherein at least some images in said plurality of images of the given target object are derived on the basis of emitted radiation.

34. A computer readable storage medium as defined in claim 29, wherein said program element when executing on said processor is operative for computing Fourier transforms associated to the respective images in the plurality of images of the given target object.

35. A computer readable storage medium as defined in claim 34, wherein said program element when executing on said processor is operative for storing data conveying images of the Fourier transforms in association with the entry corresponding to the given target object.

36. A computer readable storage medium as defined in claim 29, wherein said program element when executing on said processor is operative for storing data conveying the plurality of images of the given target object in association with the entry corresponding to the given target object.

37. A computer readable storage medium as defined in claim 29, wherein said plurality of images of the given target object includes 4 or more images.

38. A computer readable storage medium as defined in claim 29, wherein said program element when executing on said processor is operative for storing supplemental data in association with the entry corresponding to the given target object, at least part of said supplemental data being suitable for being processed by a computing apparatus to derive an image conveying pictorial information associated to the given target object.

39. A computer readable storage medium as defined in claim 29, wherein said program element when executing on said processor is operative for storing supplemental data in association with the entry corresponding to the given target object, said supplemental data conveying at least one of:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

40. An apparatus for generating an entry in a database of target objects suitable for use in screening receptacles to detect the presence of one or more target objects, said apparatus comprising:
a) an input for receiving signals conveying a plurality of images of a given target object whose presence in a receptacle it is desirable to detect during security screening, each image of the given target object in the plurality of images corresponding to the given target object in a respective orientation;
a) a processing unit in communication with said input, said processing unit being operative for:
i) processing each image in the plurality of images to generate respective filter data elements, the filter data elements being suitable for being processed by a device implementing an optical correlation operation to attempt to detect a representation of the given target object in an image of a receptacle;
ii) storing the filter data elements in the database of target objects in association with an entry corresponding to the given target object.

41. An apparatus as defined in claim 40, wherein at least some images in said plurality of images of the given target object are derived on the basis of penetrating radiation.

42. An apparatus as defined in claim 41, wherein at least some images in said plurality of images of the given target object are x-ray images.

43. An apparatus as defined in claim 40, wherein at least some images in said plurality of images of the given target object are derived on the basis of emitted radiation.

44. An apparatus as defined in claim 40, wherein said processing unit is operative for computing Fourier transforms associated to the respective images in the plurality of images of the given target object.

45. An apparatus as defined in claim 44, wherein said processing unit is operative for storing in the database of target objects data conveying images of the Fourier transforms in association with the entry corresponding to the given target object.

46. An apparatus as defined in claim 40, wherein said processing unit is operative for storing data conveying the plurality of images of the given target object in association with the entry corresponding to the given target object.

47. An apparatus as defined in claim 40, wherein said plurality of images of the given target object includes 4 or more images.

48. An apparatus as defined in claim 40, wherein said input is a first input, said apparatus comprising a second input for receiving supplemental data associated with the given target object.

49. An apparatus as defined in claim 48, wherein said processing unit is operative for storing said supplemental data in the database of target objects in association with the entry corresponding to the given target object.

50. An apparatus as defined in claim 49, wherein at least part of said supplemental data is suitable for being processed to derive an image conveying pictorial information associated to the given target object.

51. An apparatus as defined in claim 49, wherein said supplemental data conveys at least one of:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

52. An apparatus as defined in claim 40, wherein said apparatus comprises an output for releasing a signal conveying contents of said database of target objects for transmission to a facility including a security screening station for use in detecting in a receptacle the presence of one or more target objects from the database of target objects.

53. An apparatus as defined in claim 40, wherein said apparatus comprises an output for releasing a signal conveying contents of said database of target objects for transmission to a customs station for use in detecting in a receptacle the presence of one or more target objects from the database of target objects.

54. A system for generating an entry in a database of target objects suitable for use in screening receptacles to detect the presence of one or more target objects, said system comprising:
a) an image generation device suitable for generating image signals associated with a given target object whose presence in a receptacle it is desirable to detect during security screening, each image signal associated with the given target object corresponding to the given target object in a respective orientation;
b) a database of target objects suitable for storing a plurality of entries, each entry being associated to a respective target object;
c) an apparatus in communication with said image generation device and with said database of target objects, said apparatus comprising:
i) an input for receiving the image signals associated with the given target object from the image generation device;
ii) a processing unit in communication with said input, said processing unit being operative for:
1. processing the image signals associated with the given target object to generate respective filter data elements, the filter data elements being suitable for being processed by a device implementing an optical correlation operation to attempt to detect a representation of the given target object in an image of a receptacle;
2. storing the filter data elements in the database of target objects in association with an entry corresponding to the given target object.

55. A system as defined in claim 54, wherein said system comprises a positioning device for positioning the given target object in two or more distinct orientations such as to allow the image generation device to generating image signals associated with the given target object in the two or more distinct orientations.

56. A system as defined in claim 54, wherein said image generation device generates at least some image signals associated with the given target object using penetrating radiation.

57. A system as defined in claim 55, wherein said image generation device generates at least some image signals associated with the given target object using x-rays.

58. A system as defined in claim 54, wherein said image generation device generates at least some image signals associated with the given target object using emitted radiation.

59. A system as defined in claim 54, wherein said processing unit is operative for computing Fourier transforms associated to the respective image signals associated with a given target object.

60. A system as defined in claim 59, wherein said processing unit is operative for storing in the database of target objects data conveying images of the Fourier transforms in association with the entry corresponding to the given target object.

61. A system as defined in claim 54, wherein said processing unit is operative for storing in the database of target objects image data derived from the image signals associated with the given target object, the image data conveying pictorial representations of the given target object in different orientations.

62. A system as defined in claim 54, wherein the input of said apparatus is a first input, said apparatus comprising a second input for receiving supplemental data associated with the given target object.

63. A system as defined in claim 62, wherein said processing unit is operative for storing said supplemental data in the database of target objects in association with the entry corresponding to the given target object.

64. A system as defined in claim 63, wherein at least part of said supplemental data is suitable for being processed to derive an image conveying pictorial information associated to the given target object.

65. A system as defined in claim 63, wherein said supplemental data conveys at least one of:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

66. An apparatus for generating an entry in a database of target objects suitable for use in screening receptacles to detect the presence of one or more target objects, said apparatus comprising:
a) means for receiving signals conveying a plurality of images of a given target object whose presence in a receptacle it is desirable to detect during security screening, each image of the given target object in the plurality of images corresponding to the given target object in a respective orientation;
b) means for processing each image in the plurality of images to generate respective filter data elements, the filter data elements being suitable for being processed by a processing unit implementing an optical correlation operation to attempt to detect a representation of the given target object in an image of a receptacle;
c) means for storing the filter data elements in the database of target objects in association with an entry corresponding to the given target object.

67. A system for detecting the presence of one or more target objects in a receptacle, comprising:
a) an input for receiving data conveying graphic information regarding the contents of the receptacle;
b) a database of target objects comprising a plurality of entries, each entry being associated to a respective target object whose presence in a receptacle it is desirable to detect, at least one entry being associated to a given target object and including a group of sub-entries, each sub-entry being associated to the given target object in a respective orientation;
c) an optical correlator in communication with said input and with said database of target objects, said optical correlator being operative for processing the graphic information in combination with at least part of a sub-entry associated to the given target object to attempt to detect a depiction of the given target objects in an image of the receptacle.

68. A system as defined in claim 67, wherein each sub-entry in the group of sub-entries includes a component indicative of a filter, the filter being derived on the basis of an image of the given target object in a certain orientation.

69. A system as defined in claim 68, wherein the filter is indicative of a Fourier transform of the image of the given target object in the certain orientation.

70. A system as defined in claim 68, wherein the filter is indicative of an image of a Fourier transform of the image of the given target object in the certain orientation.

71. A system as defined in claim 68, wherein the filter is derived on the basis of a function of a Fourier transform of the image of the given target object in the certain orientation.

72. A system as defined in claim 68, wherein the filter is derived on the basis of a function of a Fourier transform of a composite image, the composite image including a component derived from the given target object in the certain orientation.

73. A system as defined in claim 68, wherein the entry for the given target object comprises information conveying at least one of:
a) a risk level associated with the given target object;
b) a handling procedure associated with the given target object;
c) a dimension associated with the given target object;
d) a weight data element associated with the given target object;
e) a description of the given target object; and
f) a monetary value associated with the given target object.

74. A system as defined in claim 67, wherein said system is part of a security screening station.

75. A system as defined in claim 67, wherein said system is part of a customs station.

76. A computer readable storage medium storing a database of target objects suitable for use in detecting the presence of one or more target objects in a receptacle, said database of target objects comprising:
a) a plurality of entries, each entry being associated to a respective target object whose presence in a receptacle it is desirable to detect during screening;
b) an entry for a given target object comprising:
i) a group of sub-entries, each sub-entry being associated to the given target object in a respective orientation, at least part of each sub-entry being suitable for being processed by a processing unit implementing an optical correlation operation to attempt to detect a representation of the given target object in an image of the receptacle;
ii) a data element associated with the given target object, said data element being suitable for being processed by a computing apparatus to derive a monetary value associated with the given target object.

77. A computer readable storage medium as defined in claim 76, wherein the monetary value is indicative of the value of the given target object.

78. A computer readable storage medium as defined in claim 76, wherein the monetary value is indicative of the value of the given target object for customs purposes.

79. A computer readable storage medium as defined in claim 76, wherein the data element is indicative of a weight associated to the given target object.
